(19) United States
(12) Patent Application Publication
(10) Pub. No.: US 2022/0145065 A1
(43) Pub. Date: May 12, 2022

(54) CROSS-LINKABLE NETWORK FROM FUNCTIONALIZED POLYETHERIMIDE AND THERMOSET POLYMER RESULTING THEREFROM

(71) Applicant: SHPP Global Technologies B.V., BERGEN OP ZOOM (NL)

(72) Inventors: Dadasaheb V. PATIL, Evansville, IN (US); Prakash SISTA, Evansville, IN (US)

(21) Appl. No.: 17/433,522

(22) PCT Filed: Feb. 25, 2020
(86) PCT No.: PCT/US2020/019621

§ 371 Date: Aug. 24, 2021

(30) Foreign Application Priority Data
Feb. 25, 2019 (EP) 19159168.4

(51) Int. Cl. C08L 63/00; C08G 73/10

(52) U.S. Cl. CPC C08L 63/00; C08G 73/1071; C08G 73/101; C08G 73/1017; C08G 73/1039

(57) ABSTRACT

A curable epoxy composition, comprising: an epoxy resin composition comprising one or more epoxy resins, each independently having at least two epoxy groups per molecule; an epoxy resin curing agent; optionally a curing catalyst; and a functionalized polyetherimide prepared from a substituted or unsubstituted C₄₋₄₀ bisanhydride, a substituted or unsubstituted C₁₋₄₀ organic diamine, and optionally an organic compound, wherein the functionalized polyetherimide includes a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, wherein G is an anhydride group, a carboxylic acid, a carboxylic ester, or a combination thereof, wherein the functionalized polyetherimide has a total reactive end group concentration of 50-1,500 μeq/g and 0.05-1,000 ppm by weight of residual organic diamine, wherein the functionalized polyetherimide is obtained by precipitation from a solution using an organic anti-solvent, or by devolatilization, and the organic compound comprises at least two functional groups/molecule.

### CROSS REFERENCE TO RELATED APPLICATIONS

This application claims the benefit of European Patent Application No. 19159168.4, filed Feb. 25, 2019, the entire content of which is incorporated by reference herein.

### BACKGROUND

Polyimides, in particular polyetherimides (PEI) are amorphous, transparent, high performance thermoplastic polymers having a glass transition temperature (T_{g}) of greater than 180° C. Polyetherimides further have high strength, toughness, heat resistance, and modulus, and broad chemical resistance, and so are widely used in industries as diverse as automotive, telecommunication, aerospace, electrical/electronics, transportation, and healthcare. Polyetherimides have shown versatility in various manufacturing processes, proving amenable to techniques including injection molding, extrusion, and thermoforming, to prepare various articles.

Polyetherimides can be added to curable epoxy compositions and be incorporated into cured thermosets to function, for example, as toughening agents. However, polyetherimides are typically high viscosity materials and the high viscosity, combined with the high T_{g}, can hinder their use in certain manufacturing operations. The cured thermoset also can lack the chemical resistance to commonly used solvents. There accordingly remains a need for polyetherimides suitable for use in manufacturing thermoset materials with improved properties.

### BRIEF DESCRIPTION

According to an aspect, a curable epoxy composition comprises an epoxy resin composition comprising one or more epoxy resins, each independently having at least two epoxy groups per molecule; an epoxy resin curing agent; optionally a curing catalyst; and a functionalized polyetherimide prepared from a substituted or unsubstituted C₄₋₄₀ bisanhydride, a substituted or unsubstituted C₁₋₄₀ organic diamine, and optionally an organic compound, wherein the functionalized polyetherimide is present in an amount from 5 to 75 parts by weight per 100 parts by weight of the epoxy resin composition, wherein the functionalized polyetherimide comprises a reactive end group of the formula (C₁₋₄₀hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof; wherein G is an anhydride group, carboxylic acid, carboxylic ester, or a combination thereof, wherein the functionalized polyetherimide has a total reactive end group concentration of 50 to 1,500 microequivalents per gram, preferably 50 to 1,000 microequivalents per gram, more preferably 50 to 750 microequivalents per gram of the functionalized polyetherimide, wherein the polyetherimide composition has 0.05 to 1,000 ppm by weight, preferably 0.05 to 500 ppm by weight, more preferably 0.05 to 250 ppm by weight of residual organic diamine, based on the total weight of the polyetherimide composition, as determined by ultra-performance liquid chromatography, wherein the functionalized polyetherimide is obtained by precipitation from a solution using an organic anti-solvent, or by devolatilization, and wherein the organic compound comprises at least two functional groups per molecule, wherein a first functional group is reactive with an anhydride group, an amine group, or a combination thereof, and the first functional group is different from a second functional group.

Another aspect provides a method for the manufacture of the curable epoxy composition comprising combining the epoxy resin composition and the functionalized polyetherimide at a temperature of 70 to 200° C. to provide a reaction mixture; and adding the epoxy resin curing agent and optionally the curing catalyst to the reaction mixture to provide the curable epoxy composition.

Other aspect includes an epoxy thermoset comprising a cured product of the curable epoxy composition, and an article comprising the epoxy thermoset, preferably wherein the article is in the form of a composite, an adhesive, a film, a layer, a coating, an encapsulant, a sealant, a component, a prepreg, a casing, or a combination thereof.

### BRIEF DESCRIPTION OF THE DRAWINGS

The following figures are exemplary embodiments wherein the like elements are numbered alike.

FIG. 1 are scanning electron microscopy (SEM) images of the fractured surfaces of thermoplastic polymer toughened epoxy samples according to one or more aspects.

FIG. 2 are SEM images of surfaces before and after exposure to solvent according to one or more aspects.

FIG. 3 are SEM images of fractured surfaces of thermoplastic polymer toughened epoxy samples according to one or more aspects.

### DETAILED DESCRIPTION

The inventors have prepared functionalized polyetherimide oligomers such that epoxy formulations including the same have demonstrably lower viscosity than and equivalent chemical resistance to polyethersulfone epoxy formulations at similar loading levels. The disclosed lower molecular weight, functionalized polyetherimide oligomers can be added to curable epoxy compositions with improved processability, having good solubility that provides a curable epoxy composition with a viscosity of less than or equal to 2,000 Pascal-seconds (Pa·s). Upon curing, the functionalized polyetherimide oligomers are incorporated into the cross-linked matrix of the cured thermoset resin, which improves mechanical properties. For example, the cured product can have a fracture toughness of greater than 150 Joules per square meter (J/m²) when measured according to ASTM D5045. Surprisingly, certain cured epoxy formulations including the functionalized polyetherimide oligomers provide greater fracture toughness compared to cured epoxy formulations including polyethersulfone. This is contrary to what would be expected when substituting the lower molecular weight functionalized polyetherimide oligomer for a high molecular weight polyethersulfone.

Accordingly, an aspect of the present disclosure is a curable epoxy composition comprising an epoxy resin composition comprising one or more epoxy resins, each independently having at least two epoxy groups per molecule; an epoxy resin curing agent; optionally a curing catalyst; and a functionalized polyetherimide prepared from a substituted or unsubstituted C₄₋₄₀ bisanhydride, a substituted or unsubstituted C1-40 organic diamine, and optionally an organic compound, wherein the functionalized polyetherimide is present in an amount from 5 to 75 parts by weight per 100 parts by weight of the epoxy resin composition, wherein the functionalized polyetherimide includes a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof; wherein G is an anhydride group, a carboxylic acid, a carboxylic ester, or a combination thereof; wherein the functionalized polyetherimide has a total reactive end group concentration of 50 to 1,500 microequivalents per gram, preferably 50 to 1,000 microequivalents per gram, more preferably 50 to 750 microequivalents per gram of the functionalized polyetherimide, wherein the polyetherimide composition has 0.05 to 1,000 ppm by weight, preferably 0.05 to 500 ppm by weight, more preferably 0.05 to 250 ppm by weight of residual organic diamine, based on the total weight of the polyetherimide composition, as determined by ultra-performance liquid chromatography, wherein the functionalized polyetherimide is obtained by precipitation from a solution using an organic anti-solvent, or by devolatilization, and wherein the organic compound comprises at least two functional groups per molecule, wherein a first functional group is reactive with an anhydride group, an amine group, or a combination thereof, and the first functional group is different from a second functional group.

The epoxy resin composition includes a compound of formula (1)

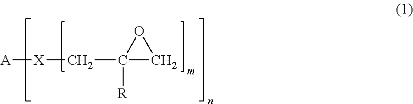

wherein A is an inorganic group or a C₁₋₆₀ hydrocarbyl group of valence n, X is oxygen or nitrogen, m is 1 or 2 and consistent with the valence of X, R is hydrogen or methyl, n is 1 to 100, preferably 1 to 8, more preferably 2 to 4. For example, A is a C₆₋₁₈ hydrocarbyl group and n is 2 or 3 or 4.

Epoxy resin compounds can include those of formulas (1a) to (1f)

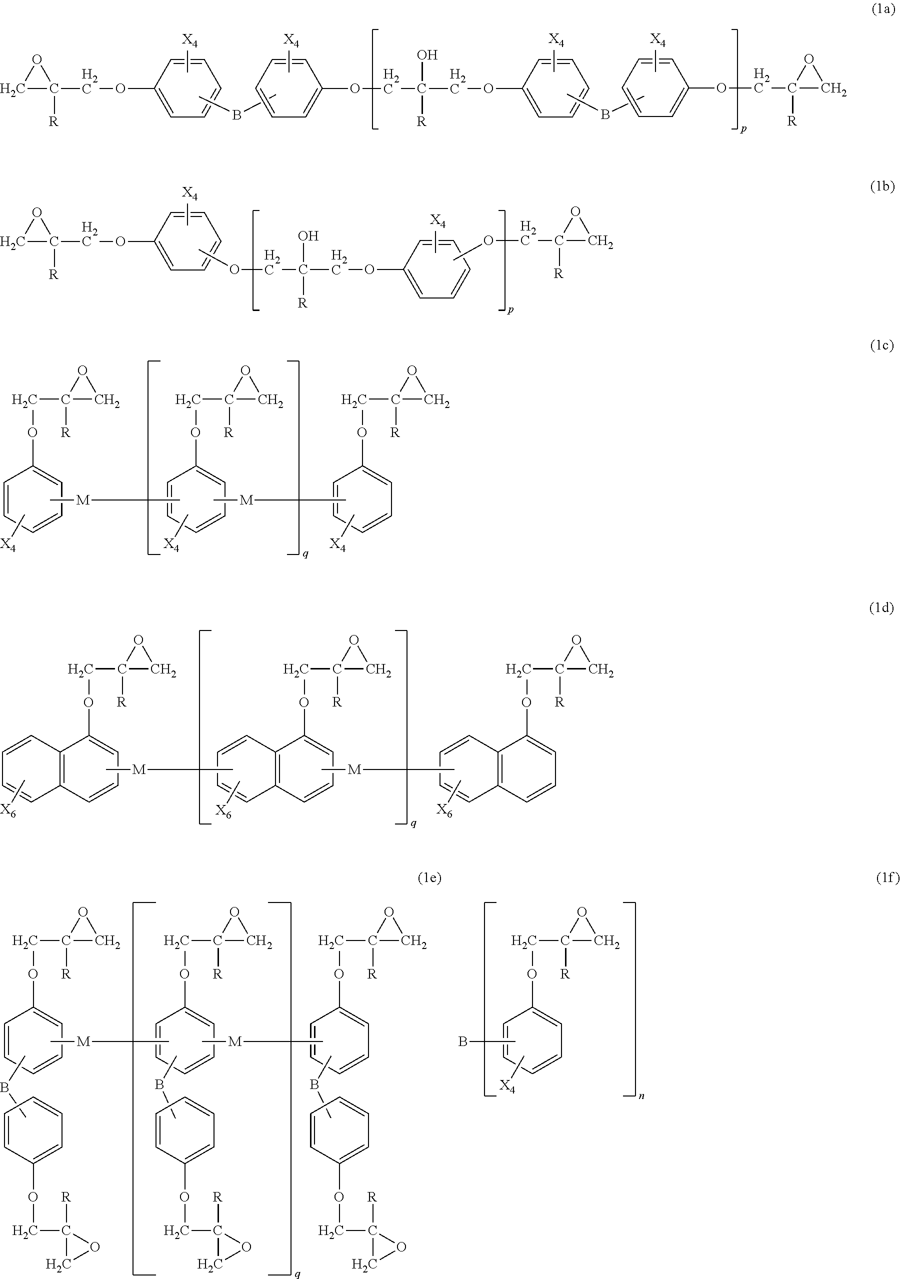

wherein each occurrence of R is independently hydrogen or methyl; each occurrence of M is independently C₁-C_{b 18} hydrocarbylene optionally further comprising an oxirane, carboxy, carboxamide, ketone, aldehyde, alcohol, halogen, or nitrile; each occurrence of X is independently hydrogen, chloro, fluoro, bromo, or C₁-C₁₈ hydrocarbyl optionally further comprising a carboxy, carboxamide, ketone, aldehyde, alcohol, halogen, or nitrile; each occurrence of B is independently a carbon-carbon single bond, C₁-C₁₈ hydrocarbyl, C₁-C₁₂ hydrocarbyloxy, C₁-C₁₂ hydrocarbylthio, carbonyl, sulfide, sulfonyl, sulfinyl, phosphoryl, silane, or such groups further comprising a carboxyalkyl, carboxamide, ketone, aldehyde, alcohol, halogen, or nitrile; n is 1 to 20; and each occurrence of p and q is independently 0 to 20.

Epoxy resin compounds include those produced by the reaction of epichlorohydrin or epibromohydrin with a phenolic compound. Exemplary phenolic compounds include resorcinol, catechol, hydroquinone, 2,6-dihydroxynaphthalene, 2,7-dihydroxynapthalene, 2-(diphenylphosphoryl)hydroquinone, bis(2,6-dimethylphenol)2,2′-biphenol, 4,4-biphenol, 2,2′-biphenol, 3,4′-biphenol, 3,3′-biphenol, 2,2′,6,6′-tetramethylbiphenol, 2,2′,3,3′,6,6′-hexamethylbiphenol, 3,3′,5,5′-tetrabromo-2,2′6,6′-tetramethylbiphenol, 3,3′-dibromo-2,2′,6,6′-tetramethylbiphenol, 2,2′,6,6′-tetramethyl-3,3′-dibromobiphenol, 4,4′-isopropylidenediphenol (bisphenol A), 4,4′-isopropylidenebis(2,6-dibromophenol) (tetrabromobisphenol A), 4,4′-isopropylidenebis(2,6-dimethylphenol) (teramethylbisphenol A), 4,4′-isopropylidenebis(2-methylphenol), 4,4′-isopropylidenebis(2-allylphenol), 4,4′-(1,3-phenylenediisopropylidene)bisphenol (bisphenol M), 4,4′-isopropylidenebis(3-phenylphenol), 4,4′-(1,4-phenylenediisoproylidene)bisphenol (bisphenol P), 4,4′-ethylidenediphenol (bisphenol E), 4,4′-oxydiphenol, 4,4′-thiodiphenol, 4,4′-thiobis(2,6-dimethylphenol), 4,4′-sulfonyldiphenol, 4,4′-sulfonylbis(2,6-dimethylphenol) 4,4′-sulfinyldiphenol, 4,4′-hexafluoroisoproylidene)bisphenol (bisphenol AF), 4,4′-(1-phenylethylidene)bisphenol (bisphenol AP), bis(4-hydroxyphenyl)-2,2-dichloroethylene (bisphenol C), bis(4-hydroxyphenyl)methane (bisphenol F), bis(2,6-dimethyl-4-hydroxyphenyl)methane, 4,4′-(cyclopentylidene)diphenol, 4,4′-(cyclohexylidene)diphenol (bisphenol Z), 4,4′-(cyclododecylidene)diphenol 4,4′-(bicyclo[2.2.1]heptylidene)diphenol, 4,4′-(9H-fluorene-9,9-diyl)diphenol, 3,3-bis(4-hydroxyphenyl)isobenzofuran-1(3H)-one, 1-(4-hydroxyphenyl)-3,3-dimethyl-2,3-dihydro-1H-inden-5-ol, 1-(4-hydroxy-3,5-dimethylphenyl)-1,3,3,4,6-pentamethyl-2,3-dihydro-1H-inden-5-ol, 3,3,3′,3′-tetramethyl-2,2′,3,3′-tetrahydro-1,1′-spirobi[indene]-5,6′-diol (spirobiindane), dihydroxybenzophenone (bisphenol K), tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane, tetrakis(3,5-dimethyl-4-hydroxyphenyl)ethane, bis(4-hydroxyphenyl)phenylphosphine oxide, dicyclopentadienylbis(2,6-dimethyl phenol), dicyclopentadienyl bis(2-methylphenol), dicyclopentadienyl bisphenol, or the like, and combinations thereof.

Examples of epoxy resin compounds include polyepoxides based on aromatic amines, such as aniline, for example N,N-diglycidylaniline, diaminodiphenylmethane and cycloaliphatic epoxy compounds such as 3,4-epoxycyclohexylmethyl-3,4-epoxycyclohexane carboxylate, 4,4′-(1,2-epoxyethyl)biphenyl, 4,4′-di(1,2-epoxyethyl)diphenyl ether, and bis(2,3-epoxycyclopentyl)ether. Other examples of epoxy resin compounds are mixed multifunctional epoxy compounds obtained from compounds that contain a combination of functional groups mentioned above, for example 4-aminophenol.

Examples epoxy resin compounds include the glycidyl ethers of phenolic compounds such as the glycidyl ethers of phenol-formaldehyde novolac, alkyl substituted phenol-formaldehyde compounds including cresol-formaldehyde novolac, t-butylphenol-formaldehyde novolac, sec-butylphenol-formaldehyde novolac, t-octylphenol-formaldehyde novolac, cumylphenol-formaldehyde novolac, decylphenol-formaldehyde novolac. Other exemplary auxiliary polyepoxide compounds are the glycidyl ethers of bromophenol-formaldehyde novolac, chlorophenolformaldehyde novolac, phenol-bis(hydroxymethyl)benzene novolac, phenol-bis(hydroxymethylbiphenyl) novolac, phenol-hydroxybenzaldehyde novolac, phenol-dicylcopentadiene novolac, naphthol-formaldehyde novolac, naphthol-bis(hydroxymethyl)benzene novolac, naphthol-bis(hydroxymethylbiphenyl) novolac, naphthol-hydroxybenzaldehyde novolac, and naphthol-dicylcopentadiene novolacs, or the like, and combinations thereof.

Examples of epoxy resin compounds include those based on heterocyclic ring systems, for example hydantoin epoxy compounds, triglycidyl isocyanurate and its oligomers, N-glycidyl phthalimide, N-glycidyltetrahydrophthalimide, urazole epoxides, uracil epoxides, and oxazolidinone-modified epoxy compounds. Oxazolidinone-modified epoxide resin compounds include those disclosed in Angew. Makromol. Chem., vol. 44, (1975), pages 151-163, and U.S. Pat. No. 3,334,110 to Schramm. An example is the reaction product of bisphenol A diglycidyl ether with diphenylmethane diisocyanate in the presence of an appropriate accelerator.

Further examples of epoxy resin compounds include polyglycidyl esters that are obtained by reacting epichlorohydrin or similar epoxy compounds with an aliphatic, cycloaliphatic, or aromatic polycarboxylic acid, such as oxalic acid, adipic acid, glutaric acid, phthalic, isophthalic, terephthalic, tetrahydrophthalic or hexahydrophthalic acid, 2,6-naphthalenedicarboxylic acid, and dimerized fatty acids. Examples include diglycidyl terephthalate and diglycidyl hexahydrophthalate. Moreover, polyepoxide compounds that contain the epoxide groups in random distribution over the molecule chain and which can be prepared by emulsion copolymerization using olefinically unsaturated compounds that contain these epoxide groups, such as, for example, glycidyl esters of acrylic or methacrylic acid, can be used.

Other exemplary epoxy resin compounds include the polyglycidyl ethers of polyhydric aliphatic alcohols. Examples of such polyhydric alcohols include 1,4-butanediol, 1,6-hexanediol, neopentyl glycol, polyalkylene glycols, glycerol, trimethylolpropane, 2,2-bis(4-hydroxycyclohexyl)propane, and pentaerythritol.

Examples of mono-functional epoxy resin compounds include 2-ethylhexyl glycidyl ether, butyl glycidyl ether, phenyl glycidyl ether, t-butyl glycidyl ether, o-cresyl glycidyl ether, and nonyl phenol glycidyl ether.

Other exemplary epoxy resin compounds include styrene oxide, neohexene oxide, and divinylbenzene dioxide, an epoxycyclohexane carboxylate such as a 3, 4-epoxycyclohexylmethyl-3, 4-epoxycyclohexane carboxylate, and a dicyclopentadiene-type epoxy compound such as dicyclopentadiene diepoxide.

Preferably, the epoxy resin compound is N,N-diglycidylaniline, 3,4-epoxycyclohexylmethyl-3,4-epoxycyclohexane carboxylate, 4,4′-di(1,2-epoxyethyl)biphenyl, 4,4′-di(1,2-epoxyethyl)diphenyl ether, bis(2,3-epoxycyclopentyl)ether, triglycidyl isocyanurate, triglycidyl-p-aminophenol, triglycidyl-p-aminodiphenyl ether, tetraglycidyldiaminodiphenylmethane, bis[4-(glycidyloxy)phenyl]methane, tetraglycidyldiaminodiphenyl ether, tetrakis(4-glycidyloxyphenyl)ethane, N,N,N′,N′-tetraglycidyl-diaminophenyl tetraglycidyl-diaminophenyl sulfone, bisphenol A diglycidyl ether, a bisphenol F epoxy resin, epoxy phenol novolac resin, epoxy cresol novolac resin, an epoxy resin containing a spiro ring, a hydantoin epoxy resin, or a combination thereof.

Epoxy resin compounds can be prepared by further condensation of an epoxy compound with a phenol such as a bisphenol. An example is the condensation of bisphenol A with a bisphenol A diglycidyl ether to produce an oligomeric diglycidyl ether. In another example a phenol dissimilar to the one used to derive the epoxy compound can be used. For example, tetrabromobisphenol A can be condensed with bisphenol A diglycidyl ether to produce an oligomeric diglycidyl ether containing halogens.

The epoxy resin compound can be a solid at room temperature. Thus, in some aspects, the epoxy resin compound has a softening point of 25 to 150° C. Softening points can be determined, for example, by differential scanning calorimetry (DSC), dynamic mechanical analysis (DMA), or ring and ball test methods as described in ASTM E28-67, ASTM E28-99, ASTM D36, ASTM D6493-11, and ISO 4625. The epoxy resin compound can be a liquid or a softened solid at room temperature. Thus, in some aspects, the epoxy resin compound has a softening point of less than 25° C.

The epoxy resin curing agent can be a diamine compound; preferably m-phenylenediamine, p-phenylenediamine, o-phenylenediamine, 3,3′-oxydianiline, 3,4′-oxydianiline, 4,4′-oxydianiline, 1,3-bis(4-aminophenoxy)benzene, 1,3-bis(3-aminophenoxy)benzene, 4,4′-diaminodiphenyl sulfone, 3,3′-diaminodiphenyl sulfone, 3,4′-diaminodiphenyl sulfone, 4,4′-methylenebis-(2,6-diethylaniline), 4,4′-methylenedianiline, diethyltoluenediamine, 4,4′-methylenebis-(2,6-dimethylaniline), 2,4-bis(p-aminobenzyl)aniline, 3,5-diethyltoluene-2,4-diamine, 3,5-diethyltoluene-2,6-diamine, m-xylylenediamine, p-xylylenediamine, diethyl toluene diamine, or a combination thereof; more preferably 4,4′-diaminodiphenyl sulfone. The curable epoxy composition can include the curing agent in an amount of 0.5 to 50 wt %, preferably 2.5 to 25 wt %, more preferably 5 to 15 wt %, based on the total weight of the curable composition.

The curable epoxy composition optionally includes a curing catalysts. The term “curing catalyst” as used herein encompasses compounds whose roles in curing epoxy compounds are variously described as those of a hardener, accelerator, catalyst, co-catalyst, or the like. The amount of curing catalyst will depend on the type of compound, as well as the identities and amounts of the other components of the composition. For example, the curable epoxy composition can include the curing catalyst in an amount of 0.5 to 50 wt %, preferably 2.5 to 25 wt %, more preferably 5 to 15 wt %, based on the total weight of the curable composition.

The curing catalyst can be an aromatic dianhydride. Exemplary aromatic dianhydrides include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4-(2,3-dicarboxyphenoxy)-4′-(3,4-dicarboxyphenoxy)diphenyl sulfone dianhydride; 4,4′-(4,4′-isopropylidenediphenoxy)bis-(phthalic anhydride), 4,4′-(hexafluoroisopropylidene)diphthalic anhydride, 4,4′-oxydiphthalic anhydride, benzophenone-3,3′,4,4′-tetracarboxylic dianhydride, 3,3′,4,4′-biphenyltetracarboxylic dianhydride, or the like.

As used herein, the term “anhydride group” includes anhydride derivatives such as carboxylic acids and carboxylate salts.

The curing catalyst can be a bicyclic anhydride. Examples of bicyclic anhydride compounds include methyl-5-norbornene-2,3-dicarboxylic anhydride, cis-5-norbornene-endo-2,3-dicarboxylic anhydride, or the like.

Other curing catalysts are heterocyclic compounds including benzotriazoles; triazines; piperazines; imidazoles such as 1-methylimidazole; cyclic amidine such as 4-diazabicyclo(2,2,2)octane, diazabicycloundecene, 2-phenyl imidazoline, or the like; N,N-dimethylaminopyridine; a sulfamidate; or a combination thereof.

The curable epoxy composition can have a viscosity that is less than or equal to 2,000 Pascal second (Pa·s), preferably less than or equal to 1,000 Pa·s, more preferably less than or equal to 500 Pa·s, as measured at 100° C. according to ASTM D4440-1.

The functionalized polyetherimide has a total reactive end group concentration of 50 to 1,500 microequivalents per gram, preferably 50 to 1,000 microequivalents per gram, more preferably 50 to 750 microequivalents per gram of the functionalized polyetherimide, as determined by nuclear magnetic resonance spectroscopy. Exemplary C₁₋₄₀ hydrocarbylenes include a substituted or unsubstituted C₁₋₁₀ alkylene or a substituted or unsubstituted C₆₋₄₀ arylene.

As used herein, the reactive end groups are groups that can interact with another polymer or prepolymer to promote the formation of cross-linking networks through chemical or physical bonding during curing and/or to promote the formation of phase-separated polyetherimide domains with morphology conducive to imparting toughness to the cured thermoset polymer. The reactive end groups are bonded to the atoms of the polyetherimide chain as chain end groups.

The total reactive end group concentration is 50 to 1,500 microequivalents per gram (μeq/g), preferably 50 to 1,000 veq/g, more 50 to 750 veq/g of the functionalized polyetherimide. The concentration of end groups can be analyzed by various titration and spectroscopic methods well known in the art. In some aspects, the concentration of end groups can be determined by nuclear magnetic resonance spectroscopy.

The concentration of end groups can be analyzed by various titration and spectroscopic methods well known in the art. Spectroscopic methods include, infrared, nuclear magnetic resonance, Raman spectroscopy, and fluorescence. Examples of infrared methods are described in J. A. Kreuz, et al., and J. Poly. Sci. Part A-1, vol. 4, pp. 2067-2616 (1966). Examples of titration methods are described in Y. J. Kim, et al., Macromolecules, vol. 26, pp. 1344-1358 (1993). It may be advantageous to make derivatives of polymer end groups to enhance measurement sensitivity using, for example, variations of methods as described in K. P. Chan et al., Macromolecules, vol. 27, p. 6731 (1994) and J. S. Chao, Polymer Bull., vol. 17, p. 397 (1987).

Polyetherimides comprise more than 1, for example 2 to 1000, or 5 to 500, or 10 to 100 structural units of formula (1)

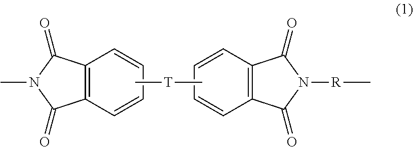

wherein each R is independently the same or different, and is a substituted or unsubstituted divalent C₁₋₄₀ organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In some embodiments R is divalent group of one or more of the following formulas (2)

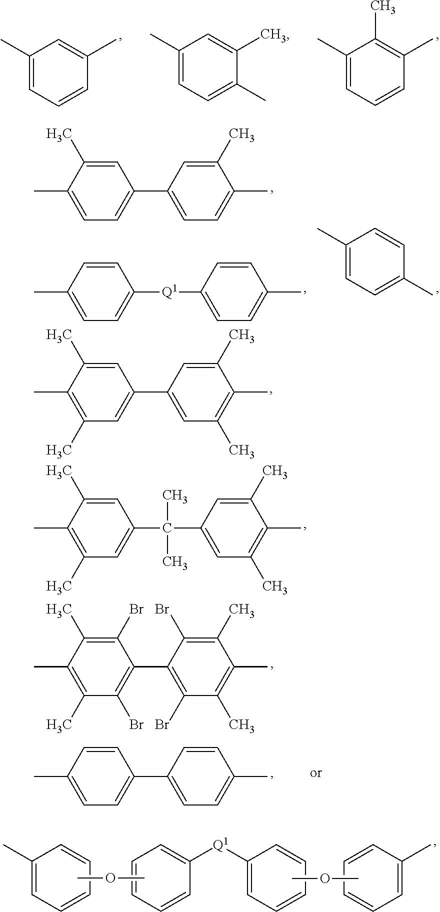

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent or at least 50 mole percent of the R groups contain sulfone groups, and in other embodiments no R groups contain sulfone groups.

Further in formula (1), T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula (3)

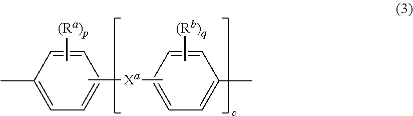

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

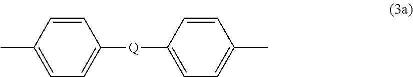

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In a specific embodiment Z is a derived from bisphenol A, such that Q in formula (3a) is 2,2-isopropylidene.

In an embodiment in formula (1), R is m-phenylene, p-phenylene, or a combination comprising at least one of the foregoing, and T is —O—Z—O— wherein Z is a divalent group of formula (3a). Alternatively, R is m-phenylene, p-phenylene, or a combination comprising at least one of the foregoing, and T is —O—Z—O wherein Z is a divalent group of formula (3a) and Q is 2,2-isopropylidene. Such materials are available under the trade name ULTEM from SABIC. Alternatively, the polyetherimide can be a copolymer comprising additional structural polyetherimide units of formula (1) wherein at least 50 mole percent (mol %) of the R groups are bis(4,4′-phenylene)sulfone, bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety, an example of which is commercially available under the trade name EXTEM from SABIC.

In some aspects, the polyetherimide can be a copolymer, for example, a polyetherimide sulfone copolymer comprising structural units of formula (1) wherein at least 50 mole % of the R groups are of formula (2) wherein Q¹ is —SO₂— and the remaining R groups are independently p-phenylene, m-phenylene, or a combination thereof; and Z is 2,2′-(4-phenylene)isopropylidene.

In some embodiments, the polyetherimide is a copolymer that optionally comprises additional structural imide units that are not polyetherimide units, for example imide units of formula (4)

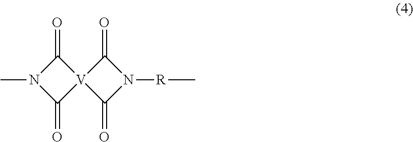

wherein R is as described in formula (1) and each V is the same or different, and is a substituted or unsubstituted C₆₋₂₀ aromatic hydrocarbon group, for example a tetravalent linker of the formulas

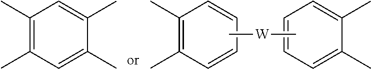

wherein W is a single bond, —O—, —S—, —C(O)—, —SO₂—, —SO—, a C₁₋₁₈ hydrocarbylene group, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide.

The polyimide or the polyetherimide can be prepared by any of the methods known to those skilled in the art, including the reaction of a C₄₋₄₀ bisanhydride of formula (5) or a chemical equivalent thereof, with a C₁₋₄₀ organic diamine of formula (6)

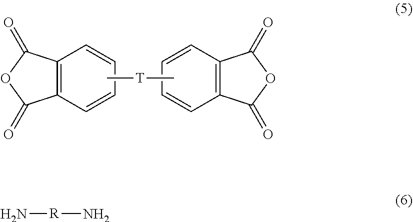

wherein T and R are defined as described above. Copolymers of the polyetherimides can be manufactured using a combination of an aromatic bis(ether anhydride) of formula (5) and an additional bis(anhydride) that is not a bis(ether anhydride), for example pyromellitic dianhydride or bis(3,4-dicarboxyphenyl) sulfone dianhydride.

Illustrative examples of C₄₋₄₀ bisanhydrides include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Exemplary C₁₋₄₀ organic diamines include ethylene diamine, propylene diamine, hexamethylenediamine, polymethylated 1,6-n-hexanediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylene-diamine, 4-methylnonamethylenediamine, 5-methylnonamethylenediamine, 2,5-dimethylhexamethylene-diamine, 2,5-dimethylheptamethylenediamine, 2, 2-dimethylpropylene-diamine, N-methyl-bis(3-aminopropyl)amine, 3-methoxyhexamethylenediamine, 1,2-bis(3-aminopropoxy)ethane, bis(3-aminopropyl)sulfide, 1,4-cyclohexanediamine, bis-(4-aminocyclohexyl)methane, m-phenylenediamine, p-phenylenediamine, o-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, oxydianiline, bis(aminophenoxy)phenyl) sulfone, bis(4-aminophenyl) sulfide, bis-(4-aminophenyl) sulfone (also known as 4,4′-diaminodiphenyl sulfone (DDS)), and bis(4-aminophenyl) ether. The C₁₋₄₀ organic diamine can be m-phenylenediamine, p-phenylenediamine, 4,4′-diaminodiphenyl sulfone, 4,4′-oxydianiline, bis(4-(4-aminophenoxy)phenyl) sulfone, or a combination thereof.

The functionalized polyetherimides also include poly(siloxane-etherimide) copolymers comprising polyetherimide units of formula (1) and siloxane blocks of formula (8)

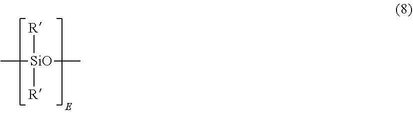

wherein E has an average value of 2 to 100, 2 to 31, 5 to 75, 5 to 60, 5 to 15, or 15 to 40, each R′ is independently a C₁₋₁₃ monovalent hydrocarbyl group. For example, each R′ can independently be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkyl, C₇₋₁₃ arylalkoxy, C₇₋₁₃ alkylaryl, or C₇₋₁₃ alkylaryloxy group, optionally halogenated. In an aspect no bromine or chlorine is present, and in another aspect no halogens are present. In an aspect, the polysiloxane blocks comprises R′ groups that have minimal hydrocarbon content, such as a methyl group.

The poly (siloxane-imide)s can be prepared from a bisanhydride (6) and an organic diamine (6) as described above or mixture of organic diamines, and a polysiloxane diamine of formula (9)

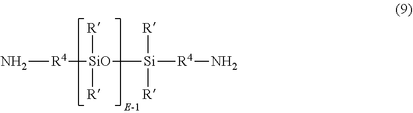

wherein R′ and E are as described in formula (8), and R⁴ is each independently a C₂-C₂₀ hydrocarbon, in particular a C₂-C₂₀ arylene, alkylene, or arylenealkylene group. In an aspect R⁴ is a C₂-C₂₀ alkylene group, and E has an average value of 5 to 100, 5 to 60, 5 to 15, or 15 to 40. The diamine component can contain 10 to 90 mol %, or 20 to 50 mol %, or 25 to 40 mol % of polysiloxane diamine (9) and 10 to 90 mol %, or 50 to 80 mol %, or 60 to 75 mol % of organic diamine (3), for example as described in U.S. Pat. No. 4,404,350. The poly(siloxane-imide) copolymer can be a block, random, or graft copolymer.

Examples of specific poly(siloxane-imide)s are described in U.S. Pat. Nos. 4,404,350, 4,808,686 and 4,690,997. In an aspect, the poly(siloxane imide) is a poly(siloxane-etherimide) and has units of formula (10)

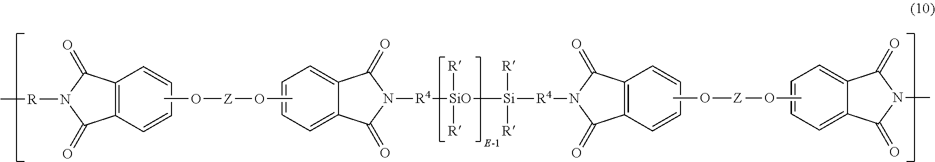

wherein R′ and E of the siloxane are as in formula (8), the R and Z of the imide are as in formulas (2) and (3), R⁴ is the same as R⁴ as in formula (9), and n is an integer from 5 to 100. In a specific aspect, the R of the etherimide is a phenylene, Z is a residue of bisphenol A, R⁴ is n-propylene, E is 2 to 50, 5, to 30, or 10 to 40, n is 5 to 100, and each R′ is methyl.

The relative amount of polysiloxane units and imide units in the poly(siloxane-imide) depends on the desired properties and are selected using the guidelines provided herein. In an aspect the poly(siloxane-imide) comprises 10 to 50 wt %, 10 to 40 wt %, or 20 to 35 wt % polysiloxane units, based on the total weight of the poly(siloxane-imide).

In some aspects, the functionalized polyetherimide is not a poly(siloxane-imide) copolymer. For example, in some aspects the functionalized polyetherimide does not comprise a poly(siloxane-imide copolymer).

The optional organic compound includes at least two functional groups per molecule. The first functional group is reactive with an anhydride, an amine, or a combination thereof, and the first functional group is different from a second functional group. For example, the organic compound can be of formula (7)

R^{c}-Lₙ-Q²-Lₙ-R^{d} (7)

wherein R^{c} and R^{d} are the different, and are each independently —OH, —NH₂, —SH, or an anhydride group, a carboxylic acid, or carboxylic ester. In formula (7), each L is the same or different, and are each independently a substituted or unsubstituted C₁₋₁₀ alkylene or a substituted or unsubstituted C₆₋₂₀ arylene; Q² is —O—, —S—, —S(O)—, —SO₂—, —C(O)—, or a C₁₋₂₀ organic bridging group, preferably a substituted or unsubstituted C₁₋₁₀ alkylene or a substituted or unsubstituted C₆₋₂₀ arylene, and each n is independently 0 or 1. It is to be understood that formula (7) is limited to chemically viable organic compounds, as would be understood to the person of skill in the art. For example, the organic compound may not be HO—O—H, and hence if Q is —O— then n is 1 in formula (7).

Exemplary organic compounds include para-aminophenol, meta-aminophenol, ortho-aminophenol, 4-hydroxy-4′-aminodiphenylpropane, 4-hydroxy-4′-aminodiphenylmethane, 4-amino-4′-hydroxydiphenyl sulfone, 4-hydroxy-4′-aminodiphenyl ether, 2-hydroxy-4-aminotoluene, 4-aminothiophenol, 3-aminothiophenol, 2-aminothiophenol, 4-hydroxyphthalic anhydride, 3-hydroxyphthalic anhydride, 6-amino-2-naphthol, 5-amino-2-naphthol, 8-amino-2-naphthol, and 3-amino-2-naphthol, or the like. One or more organic compounds can be used.

The functionalized polyetherimide can be prepared by reacting the substituted or unsubstituted C₄₋₄₀ bisanhydride, the substituted or unsubstituted C₁₋₄₀ organic diamine, and optionally the organic compound under reaction conditions effective to provide the functionalized polyetherimide. For example, the functionalized polyetherimide can be prepared by polycondensation of the bisanhydride and the organic diamine. Alternatively, the reaction includes polymerizing the substituted or unsubstituted C₄₋₄₀ bisanhydride and the substituted or unsubstituted C₁₋₄₀ organic diamine under conditions effective to provide a polyetherimide oligomer, and melt mixing the polyetherimide oligomer and the organic compound under conditions effective to provide the functionalized polyetherimide.

In particular aspects, the functionalized polyetherimide is prepared without the use of a solvent.

The bisanhydride and organic diamine can be reacted in substantially equimolar amounts or with the amine or bisanhydride in molar excess. The term “substantially equimolar amounts” means a molar ratio of bisanhydride to organic diamine of 0.9 to 1.1, preferably 0.95 to 1.05, and more preferably 0.98 to 1.02. Exemplary molar excess can be described by a molar ratio of bisanhydride to organic diamine of less than or equal to 26, or less than or equal to 20, more preferably less than or equal to 15; or 2 to 26, preferably 5 to 26, more preferably 10 to 26.

Conditions effective to provide the polyetherimide can include a temperature of 170 to 380° C., and a solids content of 1 to 50 wt %, preferably 20 to 40 wt %, more preferably 25 to 35 wt %. Polymerizations can be carried out for 2 to 24 hr, preferably 3 to 16 hr. The polymerization can be conducted at reduced, atmospheric, or high pressure.

An endcapping agent can be present during the polymerization, in particular a monofunctional compound that can react with an amine or anhydride. Exemplary compounds include monofunctional aromatic anhydrides such as phthalic anhydride, an aliphatic monoanhydride such as maleic anhydride, or monofunctional aldehydes, ketones, esters isocyanates, aromatic monoamines such as aniline, or C₁-C₁₈ linear or cyclic aliphatic monoamines. The amount of endcapping agent that can be added depends on the desired amount of chain terminating agent, and can be, for example, more than 0 to 10 mole percent (mol %), or 0.1 to 10 mol %, or 0.1 to 6 mol %, based on the moles of endcapping agent and diamine or bisanhydride reactant. In a particular aspect, no additional endcapping agent is used.

In some aspects, the functionalized polyetherimide has greater than 0.05 ppm by weight, preferably greater than 100 ppm, more preferably greater than 500 ppm, even more preferably greater than 1,000 ppm by weight of a non-reactive end group, based on the total weight of the functionalized polyetherimide

An imidization catalyst can be present during the reaction. Exemplary imidization catalysts include sodium aryl phosphinates, guanidinium salts, pyridinium salts, imidazolium salts, tetra(C₇₋₂₄ arylalkylene) ammonium salts, dialkyl heterocycloaliphatic ammonium salts, bis-alkyl quaternary ammonium salts, (C₇₋₂₄ arylalkylene)(C₁₋₁₆ alkyl) phosphonium salts, (C₆₋₂₄ aryl)(C₁₋₁₆ alkyl) phosphonium salts, phosphazenium salts, and combinations thereof. The anionic component of the salt is not particularly limited, and can be, for example, chloride, bromide, iodide, sulfate, phosphate, acetate, maculate, tosylate, and the like. A catalytically active amount of the catalyst can be determined by one of skill in the art without undue experimentation, and can be, for example, more than 0 to 5 mol % percent, or 0.01 to 2 mol %, or 0.1 to 1.5 mol %, or 0.2 to 1.0 mol % based on the moles of organic diamine.

In an embodiment, the functionalized polyetherimide is prepared from a reaction mixture including 50 to 90 wt %, preferably 60 to 90 wt %, more preferably 70 to 90 wt % of the substituted or unsubstituted C₄₋₄₀ bisanhydride; 5 to 50 wt %, preferably 15 to 50 wt %, more preferably 15 to 35 wt % of the substituted or unsubstituted C₁₋₄₀ organic diamine; and 0 to 45 wt %, preferably 0 to 35 wt %, more preferably 0 to 25 wt % of the organic compound, based on the total weight of the bisanhydride, the organic diamine, and the organic compound.

In another embodiment, the functionalized polyetherimide is prepared from a reaction mixture including 50 to 90 wt %, preferably 60 to 90 wt %, more preferably 70 to 90 wt % of the substituted or unsubstituted C₄₋₄₀ bisanhydride; 5 to 50 wt %, preferably 15 to 50 wt %, more preferably 15 to 35 wt % of the substituted or unsubstituted C₁₋₄₀ organic diamine; and 1 to 45 wt %, preferably 3 to 45 wt %, more preferably 5 to 45 wt % of the organic compound, based on the total weight of the bisanhydride, the organic diamine, and the organic compound.

The functionalized polyetherimide can have a weight average molecular weight (M_{w}) of 5,000 to 45,000 grams per mole (g/mol), preferably 10,000 to 45,000 g/mol, more preferably 15,000 to 35,000 g/mol as determined by gel permeation chromatography (GPC) using polystyrene standards. The polydispersity (PDI) can be less than 4.5, preferably less than 4.0, more preferably less than 3.0, even more preferably less than 2.8.

The functionalized polyetherimide can have a maximum absolute particle size of 1 to 1,000 micrometers (m), preferably 1 to 500 μm, more 1 to 100 μm, even more preferably 1 to 75 μm. The maximum absolute particles size is defined by the pore size of the sieve used to isolate the functionalized polyetherimide particles and does not represent an average particle size.

The functionalized polyetherimide can have an average degree of reactive end group functionality of greater than 0.75, preferably greater than 0.9, more preferably greater than 1.1, even more preferably greater than 1.5. The average degree of reactive end group functionality is defined as the average number of hydroxyl, amino, and carboxylic acid end groups per polyetherimide chain.

The functionalized polyetherimide can have a glass transition temperature (T_{g}) of greater than 155° C., preferably greater than 175° C., more preferably greater than 190° C. For example, the T_{g} can be 155 to 280° C., preferably 175 to 280° C., more preferably 190 to 280° C., as determined by differential scanning calorimetry according to ASTM D3418.

The functionalized polyetherimide can have an amide-acid concentration of 0.5 to 5000 microequivalents per gram, preferably 0.5 to 1000 microequivalents per gram, more preferably 0.5 to 500 microequivalents per gram of the functionalized polyetherimide, as determined by nuclear magnetic resonance spectroscopy.

The curable composition can include less than 0.05 to 5,000 ppm by weight, preferably 0.05 to 1000 ppm by weight, more preferably 0.05 to 500 ppm by weight, even more preferably 0.05 to 250 ppm of residual solvent, based on the total weight of the functionalized polyetherimide.

The curable composition can include 0.05 to 1,000 ppm by weight, preferably 0.05 to 750 ppm by weight, more preferably 0.05 to 500 ppm by weight each of a residual bisanhydride and a residual organic compound used to prepare the functionalized polyetherimide, based on the total weight of the curable composition.

The curable composition can include 0.05 to 3,000 ppm by weight, preferably 0.05 to 2,000 ppm by weight, more preferably 0.05 to 1,000 ppm by weight, even more preferably 0.05 to 500 ppm by weight of a total content of residual bisanhydride, residual diamine, and residual organic compound that were used to prepared the functionalized polyetherimide, based on the total weight of the curable composition.

As used herein, “residual bisanhydride” means the remaining substituted or unsubstituted C₄₋₄₀ bisanhydride from the preparation of the functionalized polyimide. As used herein, “residual organic compound” means the remaining organic compound, if any, from the preparation of the functionalized polyimide. As used herein, “residual diamine” means the remaining substituted or unsubstituted C₁₋₄₀ organic diamine from the preparation of the functionalized polyimide.

The curable composition can include 0.1 to 100 ppm by weight, 0.1 to 75 ppm by weight, 0.1 to 25 ppm by weight of a metal ion based on the total weight of the curable composition. Examples of metal ions may include but not limited to Na, K, Ca, Zn, Al, Cu, Ni, P, Ti, Mg, Mn, Si, Cr, Mo, Co and Fe.

The curable composition can include 0.1 to 200 ppm by weight, 0.1 to 100 ppm by weight, 0.1 to 50 ppm, 0.1 to 25 ppm by weight of a total content of metal ions based on the total weight of the curable composition. Examples of metal ions may include but not limited to Na, K, Ca, Zn, Al, Cu, Ni, P, Ti, Mg, Mn, Si, Cr, Mo, Co and Fe.

The curable composition can include 0.3 to 500 ppm by weight, 0.3 to 250 ppm by weight of an anion based on the total weight of the curable composition. Examples of anions may include but not limited to phosphate, nitrate, nitrite, sulfate, bromide, fluoride, and chloride.

The curable composition can further comprise additives for polyetherimide compositions generally known in the art, with the provision that the additive(s) are selected so as to not significantly adversely affect the desired properties of the compositions, in particular formation of the poly(imide). Such additives include a particulate filler, a fibrous filler, an antioxidant, a heat stabilizer, a light stabilizer, a ultraviolet light stabilizer, a ultraviolet light-absorbing compound, a near infrared light-absorbing compound, an infrared light-absorbing compound, a plasticizer, a lubricant, a release agent, a antistatic agent, storage stabilizer, ozone inhibitors, optical stabilizer, thickener, conductivity-impacting agent, radiation interceptor, nucleating agent, an anti-fog agent, an antimicrobial agent, a metal inactivating agent, a colorant, a surface effect additive, a radiation stabilizer, a flame retardant, an anti-drip agent, a fragrance, an adhesion promoter, a flow enhancer, a coating additive, a polymer different from the one or more epoxy resins, or a combination thereof. The total amount of the additive composition can be 0.001 to 20 wt %, or 0.01 to 10 wt %, based on the total weight of the curable composition.

The functionalized polyetherimide can be further processed to obtain a powder having a specified maximum particle size. Processing includes grinding, milling, cryo grinding, sieving, and combinations thereof. The processed polyetherimide powder has a weight average molecular weight, PDI and reactive end group content that corresponds to the functionalized polyetherimide because processing does not affect these properties. The processed powder can be sieved to attain a desired maximum particle size. In one aspect, the maximum particle size is 1,000 micrometers. In another aspect, a maximum absolute particle size of 1 to 1,000 micrometers, preferably 1 to 500 micrometers, more preferably 1 to 100 micrometers, even more preferably 1 to 75 micrometers, as determined by pore size of a sieve used to isolate the functionalized polyetherimide.

The functionalized polyetherimide can also be combined, for example blended, with other polymers to form a polymer blend, and the polymer blend can be used in the curable epoxy composition. Polymers that can be used include polyacetals, poly(meth)acrylates, poly(meth)acrylonitriles, polyamides, polycarbonates, polydienes, polyesters, polyethers, polyetherether ketones, polyetherimides, polyethersulfones, polyfluorocarbons, polyfluorochlorocarbons, polyimides, poly(phenylene ether), polyketones, polyolefins, polyoxazoles, polyphosphazenes, polysiloxanes, polystyrenes, polysulfones, polyurethanes, polyvinyl acetates, polyvinyl chlorides, polyvinylidene chlorides, polyvinyl esters, polyvinyl ethers, polyvinyl ketones, polyvinyl pyridines, polyvinyl pyrrolidones, and copolymers thereof, for example polyetherimide siloxanes, ethylene vinyl acetates, acrylonitrile-butadiene-styrene, or a combination thereof. Preferably, the functionalized polyetherimide can be combined with another polymer such as polyarylate, polyamide, polyimide, polyetherimide, poly(amide imide), poly(aryl ether), phenoxy resins, poly(aryl sulfone), poly(ether sulfone), poly(phenylene sulfone), poly(ether ketone), poly(ether ether ketone), poly(ether ketone ketone), poly(aryl ketone), poly(phenylene ether), polycarbonate, carboxyl-terminated butadiene-acrylonitrile (CTBN), amine-terminated butadiene-acrylonitrile (ATBN), epoxy-terminated butadiene-acrylonitrile (ETBN), core-shell rubber particles, or a combination thereof.

Also provided is a method for the manufacture of the curable epoxy composition comprising combining the epoxy resin composition and the functionalized polyetherimide at a temperature of 70 to 200° C. to provide a reaction mixture; and adding the epoxy resin curing agent, optionally a curing catalyst to the reaction mixture to provide the curable epoxy composition. The thermoplastic polymer(s) including functionalized polyetherimides can be added to the epoxy resin composition as particles that are dissolved in the resin mixture by heating prior to addition of the insoluble particles and epoxy curing agent. Once the thermoplastic polymer(s) is substantially dissolved in the hot matrix resin precursor (i.e. blend of epoxy resins), the precursor can be cooled and the remaining components (e.g., epoxy curing agents, insoluble thermoplastics, other additives, or combinations thereof) are added.

The method for the manufacture of an epoxy thermoset comprises polymerizing and crosslinking the curable epoxy composition. Curing can be accomplished using any method known in the art, for example heating, UV-visible radiation, microwave radiation, electron beam, gamma radiation, or a combination thereof.

The cured epoxy thermoset can have a glass transition temperature of 50 to 300° C., preferably 150 to 300° C., more preferably 190 to 300° C., even more preferably 210 to 300° C. or even more preferably 230 to 300° C.

The cured epoxy thermoset can have a fracture toughness of greater than or equal to 150 Joules per square meter (J/m²), preferably greater than or equal to 200 J/m², more preferably greater than or equal to 250 J/m², as measured according to ASTM D5045.

The cured epoxy thermoset can have a solvent resistance to methylene chloride, tetrachloroethane, dichlorobenzene, chloroform, dichloroethane, methyl ethyl ketone, acetone, methyl isobutyl ketone, methyl isopropyl ketone, ethyl acetate, N-methyl pyrrolidone, dimethylacetamide, dimethylformamide, dimethylsulfoxide, or a combination thereof. The cured epoxy thermoset can have a solvent resistance to less aggressive solvents including hydraulic fluid, jet fuel, gasoline, alcohols, and other organic solvents. As used herein, “solvent resistance” means the cured epoxy thermoset exhibits no substantial loss of thermoplastic material (no etching) when immersed in a solvent at 20 to 25° C. for greater than 30 minutes, preferably greater than 24 hours, more preferably from 2 to 7 days, as observed by microscopy.

The epoxy thermoset can be used in a variety of forms for various purposes, including a composite (e.g. composite materials such as those using carbon fiber and fiberglass reinforcements), a foam, a fiber, a layer, a coating, an encapsulant, an adhesive, a sealant, a sizing resin, a prepreg, a casing, a component, or a combination thereof. The epoxy thermosets can be used to form a number of articles in the aerospace, automobile, rail, marine, electronics, industrial, oil & gas, sporting good, infrastructure, energy, and other industries where improved toughness, higher heat and good resistance to solvent are needed. In certain aspects, the composite is a glass fiber-based composite, a carbon fiber-based composite, or a combination thereof.

Methods of forming a composite can include impregnating a reinforcing structure with the curable epoxy composition; partially curing the curable composition to form a prepreg; and laminating a plurality of prepregs; wherein the curable epoxy composition optionally includes an auxiliary co-monomer, and optionally, one or more additional additives.

Exemplary applications for the curable epoxy compositions include, for example, acid bath containers; neutralization tanks; aircraft components; bridge beams; bridge deckings; electrolytic cells; exhaust stacks; scrubbers; sporting equipment; stair cases; walkways; automobile exterior panels such as hoods and trunk lids; floor pans; air scoops; pipes and ducts, including heater ducts; industrial fans, fan housings, and blowers; industrial mixers; boat hulls and decks; marine terminal fenders; tiles and coatings; building panels; business machine housings; trays, including cable trays; concrete modifiers; dishwasher and refrigerator parts; electrical encapsulants; electrical panels; tanks, including electrorefining tanks, water softener tanks, fuel tanks, and various filament-wound tanks and tank linings; furniture; garage doors; gratings; protective body gear; luggage; outdoor motor vehicles; pressure tanks; printed circuit boards; optical waveguides; radomes; railings; railroad parts such as tank cars; hopper car covers; car doors; truck bed liners; satellite dishes; signs; solar energy panels; telephone switchgear housings; tractor parts; transformer covers; truck parts such as fenders, hoods, bodies, cabs, and beds; insulation for rotating machines including ground insulation, turn insulation, and phase separation insulation; commutators; core insulation and cords and lacing tape; drive shaft couplings; propeller blades; missile components; rocket motor cases; wing sections; sucker rods; fuselage sections; wing skins and flarings; engine narcelles; cargo doors; tennis racquets; golf club shafts; fishing rods; skis and ski poles; bicycle parts; transverse leaf springs; pumps, such as automotive smog pumps; electrical components, embedding, and tooling, such as electrical cable joints; wire windings and densely packed multi-element assemblies; sealing of electromechanical devices; battery cases; resistors; fuses and thermal cut-off devices; coatings for printed wiring boards; casting items such as capacitors, transformers, crankcase heaters; small molded electronic parts including coils, capacitors, resistors, and semiconductors; as a replacement for steel in chemical processing, pulp and paper, power generation, and wastewater treatment; scrubbing towers; pultruded parts for structural applications, including structural members, gratings, and safety rails; swimming pools, swimming pool slides, hot-tubs, and saunas; drive shafts for under the hood applications; dry toners for copying machines; marine tooling and composites; heat shields; submarine hulls; prototype generation; development of experimental models; laminated trim; drilling fixtures; bonding jigs; inspection fixtures; industrial metal forming dies; aircraft stretch block and hammer forms; vacuum molding tools; flooring, including flooring for production and assembly areas, clean rooms, machine shops, control rooms, laboratories, parking garages, freezers, coolers, and outdoor loading docks; electrically conductive compositions for antistatic applications; for decorative flooring; expansion joints for bridges; injectable mortars for patch and repair of cracks in structural concrete; grouting for tile; machinery rails; metal dowels; bolts and posts; repair of oil and fuel storage tanks, and numerous other applications.

This disclosure is further illustrated by the following examples, which are non-limiting.

### EXAMPLES

The components in Table 1 were used to prepare Examples 1 to 8.

TABLE 1

| | | CAS | |
|---|---|---|---|
| Component | Description | Reg. No. | Source |
| BPADA | 2,2-bis[4-(3,4-dicarboxyphenoxy)phenyl]propane | 38103-06-9 | SABIC |
| | dianhydride (4,4′-Bisphenol A dianhydride) | | |
| mPD | m-Phenylenediamine | 108-45-2 | SABIC |
| PAP | p-Aminophenol | 204-616-2 | Sigma Aldrich |
| oDCB | Ortho-Dichlorobenzene | 95-50-1 | Fisher Scientific |
| Me0H | Methanol | 67-56-1 | Fisher Scientific |
| DCM | Methylene chloride | 75-09-2 | Fisher Scientific |
| DDS | 4,4′-Diaminodiphenyl sulfone | 80-08-0 | SABIC |
| TGAP | N,N-Diglycidyl-4-glycidyloxyaniline, epoxy equivalent | 5026-74-4 | Sigma Aldrich |
| | weight (EEW) of 95 grams per equivalent (g/eq) | | |
| TGDDM | 4,4′-Methylenebis(N,N-diglycidylaniline), EEW of 117 g/eq | 28768-32-3 | Sigma Aldrich |
| BISF | Bis[4-(glycidyloxy)phenyl]methane, EEW of 160.4 g/eq | 218-257-4 | Carbosynth |
| DGEBA | Bisphenol A diglycidyl ether, EEW of 187.4 g/eq; obtained | | |
| | as EPON 828 | 216-823-5 | EV Roberts |
| PEI | Polyetherimide comprising structural units derived from | 61128-46-9 | SABIC |
| | bisphenol A dianhydride and m-phenylene diamine, and | | |
| | having a weight average molecular weight (M_{w}) of 44 kg/ | | |
| | mol as determined by GPC using polystyrene standard, | | |
| | and a particle size of less than 300 μm (sieved); obtained | | |
| | as ULTEM 1010 | | |
| PESU | Chloro- and hydroxy-functionalized polyethersulfone, | 25135-51-7 | Solvay |
| | M_{w} = 43.2 kg/mol as determined by GPC using | | |
| | polystyrene standard, OH end groups of 80 μeq/g, | | |
| | particle size of less than 300 μm (as sieved) | | |

Viscosity. Viscosity measurements were performed using a disposable 8 mm plate with 10% strain at a fixed gap of 1 mm and a constant frequency (15 rad/s) using an ARES G2 strain controller rheometer according to ASTM D4440-1. Samples were loaded between two plates of the parallel plate rheometer equilibrated to 140° C. Complex viscosity was measured as a function of temperature as the plates and the sample cooled to 70° C.

Fracture toughness. After curing, the samples were removed from the mold and milled to achieve a substantially flat, uniform surface. The sample castings were dry polished on both sides with 600 grit sand paper to a final thickness of 8 mm. A sharp pre-crack was initiated from the notch tip using a razor tap method by applying a small impact force to a sharp razor blade that is resting on a test sample. After pre-cracking, samples were mounted on a tension test clevis and tested under opening mode I load, applied with a universal test machine (Zwick Z2.5). Loads were applied under displacement control at 1 mm/min. Post-test, fractured surfaces of the samples were imaged under a light microscope to measure the crack length created by the tapping method according to ASTM D5045. The crack lengths were measured at five equal intervals on the fracture surface and averaged to obtain an average crack length for each specimen. The load at failure was recorded and used along with the specimen geometry and the average crack length to calculate the fracture toughness (K_{IC}) for the epoxy material according to ASTM D5045. The critical strain energy release rate (G_{IC}) was also calculated.

Glass transition temperature. Differential scanning calorimetry (DSC) was performed with a TA Q1000 DSC instrument according to ASTM D3418. The samples were scanned from 40 to 325° C. with a heating rate of 20° C./min under a nitrogen atmosphere. The glass transition temperature (T_{g}), and the melting temperature (Tₘ) were determined from the second heating scan.

SEM imaging of the samples was carried out using a JEOL JSM-IT500 HR scanning electron microscope. SEM images were taken under secondary electron mode with operating voltage of 10-15 kV. The samples were air cleaned and sputter coated with 10 nm gold/palladium prior to imaging. Secondary electron and back scattered electron detectors were used for morphology and Z-contrast imaging.

Table 2 provides curing profile for the samples. The time is provided as the amount of equilibration time or hold time at the specified temperature. After the final step, the samples were allowed to gradually cool to ambient temperature to minimize thermal stress.

TABLE 2

| Temperature (° C.) | Time (min) |
|---|---|
| 140 | 60 |
| 160 | 60 |
| 180 | 60 |
| 200 | 30 |
| 220 | 30 |

### Example 1. Synthesis of Amine-Terminated PEI Oligomer

To an oven-dried, 3-neck, 500 mL round-bottomed flask equipped with a mechanical stirrer, nitrogen adapter and Dean-Stark condenser was added 50.06 grams (g) of BPA-DA (94.6 mmol), 14.6 g of MPD (134.5 mmol), and 200 g of oDCB. The oil bath temperature was increased to 180° C. and the reaction was refluxed at this temperature for 3 to 4 hours. A small sample was withdrawn for molecular weight measurement. The reaction was stoichiometrically corrected with DA or amine to obtain targeted M_{w}. Once the M_{w} was achieved, the reaction mixture was allowed to cool to room temperature (ca. 25° C.) and then 150 g of DCM was added thereto, and the contents were vigorous mixed with stirring to provide and oligomer solution. The oligomer solution was slowly added into a 2 L beaker containing 800 to 850 mL of MeOH under high shear mixing conditions, resulting in the formation of a precipitate. The resultant fine off-white powder was filtered and washed with MeOH (2×50 mL). The isolated solids were dried in a vacuum oven at 130 to 135° C. for 12 hours to obtain the amine-terminated PEI oligomer as a powder having a M_{w} of 5,766 g/mol and polydispersity index (PDI) of 2.37.

### Example 2. Synthesis of Amine-Terminated PEI Oligomer

Following the same procedure as in Example 1, except 50 g of BPA-DA (94.17 mmol), 12.40 g of mPD (114 mmol), and 200 g of oDCB yielded an amine-terminated PEI oligomer powder having a M_{w} of 9,872 g/mol and a PDI of 2.12.

### Example 3. Synthesis of Hydroxy-Terminated PEI Oligomer

Following the same procedure as in Example 1, except 56.10 g of BPA-DA (107.74 mmol), 7.80 g of mPD (72.13 mmol), 8.01 g of PAP (73.31 mmol), and 200 g of oDCB yielded a hydroxy-terminated PEI oligomer powder having a M_{w} of 4,598 g/mol and a PDI of 2.32.

### Example 4. Synthesis of Hydroxy-Terminated PEI Oligomer

Following the same procedure as in Example 1, except 52.20 g of BPA-DA (97.47 mmol), 8.97 g of mPD (82.95 mmol), 3.50 g of PAP (32.07 mmol), and 200 g of oDCB yielded a hydroxy-terminated PEI oligomer powder having a M_{w} of 9,214 g/mol and a PDI of 2.42.

### Example 5. Preparation of Epoxy Casting without an Additive

The following procedure was used to prepare epoxy castings with a liquid epoxy compound (e.g., TGAP, TGDDM, BFDGE, or DGEBA) and not including a thermoplastic additive. 80 g of the liquid epoxy was poured into a 500 mL reaction kettle equipped with a mechanical stirrer and a N₂ gas inlet. The kettle was purged with N₂ gas for about 5 minutes and then was immersed in an oil bath maintained at 140° C. After about 15 to 20 minutes of heating under N₂ atmosphere, 24 g (15% excess epoxy per N—H group) of DDS was carefully added to the kettle. The solid DDS was allowed to dissolve into the liquid epoxy for about 15 minutes. After complete dissolution of DDS, the contents of the kettle were then placed under vacuum for 5 minutes followed by N₂ purge. This process was repeated for a total of three cycles, and then the resulting mixture was poured into a silicone mold that was preheated in an oven at 140° C. The samples were cured according to the thermal curing protocol in Table 2.

### Example 6. Preparation of Epoxy Casting with an Additive

The following procedure was used to prepare epoxy castings with a liquid epoxy compound (e.g., TGAP, TGDDM, BFDGE, or DGEBA) and a thermoplastic additive (e.g., PEI oligomers of Examples 1 to 4, PEI, or PESU). For each sample, 15, 30, or 50 wt % of a thermoplastic additive (based on the total weight of the liquid epoxy compound) was combined in the kettle with the liquid epoxy compound and heated to 140° C. After the thermoplastic additive completely dissolved in the liquid epoxy compound (as determined visually by the formation of a clear mixture), DDS was added to the resulting epoxy mixture. The remaining steps were performed according to the method Example 5.

To enhance solubility in the liquid epoxy compound, the thermoplastic additives were prepared as powders and a 300 μm sieve was used to remove the larger sized particles. Visual monitoring showed that the thermoplastic additives of Examples 1 to 4 dissolved in the liquid epoxy compound in about 20 to 25 minutes compared to the 45 to 60 minutes needed to dissolve PEI or PESU. For Examples 1 to 4, the nature of reactive functionality (amine vs hydroxy) and molecular weight (5 vs 10 kg/mol) did not substantially alter the dissolution time.

### Example 7. Synthesis of Amine-Terminated PEI Oligomer

Following the same procedure as in Example 1, 65 g of BPA-DA (121.56 mmol), 14.83 g of mPD (137.14 mmol), and 230 g of oDCB yielded an amine-terminated PEI oligomer powder having a M_{w} of 17,819 g/mol and a PDI of 2.42.

### Example 8. Synthesis of Amine-Terminated PEI Oligomer

Following the same procedure as in Example 1, 65 g of BPA-DA (121.37 mmol), 14.12 g of mPD (130.57 mmol), and 230 g of oDCB yielded an amine-terminated PEI oligomer powder having a M_{w} of 26,180 g/mol and a PDI of 2.36.

### Example 9. Synthesis of Amine-Terminated PEI Oligomer

Following the same procedure as in Example 1, 64.8 g of BPA-DA (121.00 mmol), 13.84 g of mPD (127.99 mmol), and 230 g of oDCB yielded an amine-terminated PEI oligomer powder having a M_{w} of 32,968 g/mol and a PDI of 2.35.

The viscosity for curable epoxy compositions and critical strain energy release for cured samples of BISF and a thermoplastic additive (0 to 50 wt %) are shown in Table 4.

TABLE 4

| | | | Viscosity | Viscosity | |
|---|---|---|---|---|---|
| | Thermo- | Loading | at 70° C. | at 100° C. | G_{IC} |
| Epoxy | plastic | (wt %) | (Pa · s) | (Pa · s) | (J/m²) |
| BISF | — | 0 | 0.36 | 0.05 | 157 |
| BISF | PEI | 15 | 46.18 | 3.22 | 279 |
| BISF | PESU | 15 | 14.04 | 1.37 | 200 |
| BISF | Example 2 | 15 | 3.59 | 0.31 | 203 |
| BISF | Example 1 | 15 | 4.31 | 0.30 | 144 |
| BISF | Example 4 | 15 | 12.10 | 0.68 | 138 |
| BISF | Example 3 | 15 | 7.72 | 0.48 | 207 |
| BISF | PEI | 30 | 307.10 | 57.97 | 1023 |
| BISF | PESU | 30 | 180.38 | 15.98 | 182 |
| BISF | Example 2 | 30 | 40.25 | 1.90 | 171 |
| BISF | Example 1 | 30 | 24.85 | 1.11 | 183 |
| BISF | Example 4 | 30 | 108.51 | 3.63 | 154 |
| BISF | Example 3 | 30 | 32.87 | 1.41 | 161 |
| BISF | Example 2 | 50 | 415.94 | 10.35 | 268 |
| BISF | Example 4 | 50 | 503.49 | 14.97 | 228 |

The viscosity for curable epoxy compositions and critical strain energy release for cured samples of DGEBA and a thermoplastic additive (0 to 50 wt %) are shown in Table 5.

TABLE 5

| | | | Viscosity | Viscosity | |
|---|---|---|---|---|---|
| | Thermo- | Loading | at 70° C. | at 100° C. | G_{IC} |
| Epoxy | plastic | (wt %) | (Pa · s) | (Pa · s) | (J/m²) |
| DGEBA | — | 0 | 1.18 | 0.09 | 164 |
| DGEBA | PEI | 15 | 80.39 | 8.38 | 245 |
| DGEBA | PESU | 15 | 94.08 | 4.73 | 227 |
| DGEBA | Example 2 | 15 | 32.88 | 1.19 | 168 |
| DGEBA | Example 1 | 15 | 58.00 | 1.84 | 155 |
| DGEBA | Example 4 | 15 | 63.73 | 2.07 | 160 |
| DGEBA | Example 3 | 15 | 51.14 | 1.48 | 156 |
| DGEBA | PEI | 30 | 846.73 | 187.06 | 578 |
| DGEBA | PESU | 30 | 255.08 | 53.72 | 147 |
| DGEBA | Example 2 | 30 | 419.59 | 9.55 | 285 |
| DGEBA | Example 1 | 30 | 286.32 | 4.96 | 227 |
| DGEBA | Example 4 | 30 | 494.46 | 9.11 | 274 |
| DGEBA | Example 3 | 30 | 1064.29 | 16.03 | 233 |
| DGEBA | Example 2 | 50 | 2697.84 | 79.65 | 281 |
| DGEBA | Example 4 | 50 | 2417.77 | 67.73 | 214 |

The viscosity for curable epoxy compositions and critical strain energy release for cured samples of TGAP and a thermoplastic additive (0 to 50 wt %) are shown in Table 6.

TABLE 6

| | | | Viscosity | Viscosity | |
|---|---|---|---|---|---|
| | Thermo- | Loading | at 70° C. | at 100° C. | G_{IC} |
| Epoxy | plastic | (wt %) | (Pa · s) | (Pa · s) | (J/m²) |
| TGAP | — | 0 | 1.41 | 0.15 | 107 |
| TGAP | PEI | 15 | 15.89 | 1.70 | 319 |
| TGAP | PESU | 15 | 35.72 | 2.71 | 262 |
| TGAP | Example 2 | 15 | 8.62 | 0.59 | 206 |
| TGAP | Example 1 | 15 | 8.65 | 0.56 | 155 |
| TGAP | Example 4 | 15 | 12.11 | 0.74 | 175 |
| TGAP | Example 3 | 15 | 18.23 | 0.98 | 123 |
| TGAP | Example 8 | 15 | — | — | 252 |
| TGAP | Example 9 | 15 | — | — | 223 |
| TGAP | PEI | 30 | 145.70 | 11.59 | 1131 |
| TGAP | PESU | 30 | 216.27 | 18.24 | 444 |
| TGAP | Example 2 | 30 | 88.41 | 3.60 | 324 |
| TGAP | Example 1 | 30 | 197.32 | 5.22 | 155 |
| TGAP | Example 4 | 30 | 104.64 | 4.31 | 310 |
| TGAP | Example 3 | 30 | 97.68 | 3.34 | 179 |
| TGAP | Example 2 | 50 | 497.36 | 12.80 | 230 |
| TGAP | Example 4 | 50 | 536.28 | 25.83 | 273 |
| TGAP | Example 8 | 30 | — | — | 586 |
| TGAP | Example 9 | 30 | — | — | 720 |

The viscosity for curable epoxy compositions, critical strain energy release for cured samples, and T_{g} for cured samples of TGDDM and a thermoplastic additive (0 to 50 wt %) are shown in Table 7.

TABLE 7

| | | | | Viscosity | Viscosity | |
|---|---|---|---|---|---|---|
| | Thermo- | Loading | Tg | at 70° C. | at 100° C. | G_{IC} |
| Epoxy | plastic | (wt %) | (° C.) | (Pa. s) | (Pa · s) | (J/m²) |
| TGDDM | — | 0 | 232.5 | 9.16 | 0.52 | 121 |
| TGDDM | PEI | 15 | 236.4 | 65.03 | 9.39 | 239 |
| TGDDM | PESU | 15 | 231.7 | 356.23 | 18.64 | 113 |
| TGDDM | Example 2 | 15 | 235.8 | 119.69 | 3.74 | 127 |
| TGDDM | Example 1 | 15 | 233.7 | 186.15 | 4.03 | 124 |
| TGDDM | Example 4 | 15 | 231.5 | 171.49 | 4.38 | 156 |
| TGDDM | Example 3 | 15 | 235.6 | 216.37 | 4.76 | 109 |
| TGDDM | Example 8 | 15 | — | — | — | 225 |
| TGDDM | Example 9 | 15 | — | — | — | 210 |
| TGDDM | PEI | 30 | — | 86.99 | 205.56 | 1051 |
| TGDDM | PESU | 30 | — | 1053.69 | 185.52 | 162 |
| TGDDM | Example 2 | 30 | — | 941.17 | 21.78 | 330 |
| TGDDM | Example 1 | 30 | — | 1186.68 | 15.71 | 177 |
| TGDDM | Example 4 | 30 | — | 1151.05 | 40.96 | 310 |
| TGDDM | Example 3 | 30 | — | 1770.71 | 34.60 | 216 |
| TGDDM | Example 2 | 50 | — | 3438.98 | 116.09 | 321 |
| TGDDM | Example 4 | 50 | — | 1653.18 | 300.47 | 354 |
| TGDDM | Example 8 | 30 | — | — | — | 322 |
| TGDDM | Example 9 | 30 | — | — | — | 492 |

The results in Tables 4 to 7 demonstrate that the viscosities of the curable epoxy compositions including a 50 wt % loading of the thermoplastic additives of Example 2 and 4 are greater than the viscosity of the curable epoxy compositions including PESU at 70° C., although at 100° C. some of the curable epoxy compositions have a lower viscosity compared to PESU. At 30 wt % loading levels, the curable epoxy compositions including the thermoplastic additives of Examples 1 and 3 had a higher viscosity at 70° C. compared to the curable epoxy compositions including the thermoplastic additives of Examples 2 and 4.

The samples derived from the curable epoxy compositions including the thermoplastic additives of Examples 2 and 4 demonstrated significant improvement in fracture toughness, for example up to a 160% increase in fracture toughness compared to the curable compositions without a thermoplastic additive. The fracture toughness of the samples including the thermoplastic additives of Examples 2 and 4 increased with higher loadings until a maximum was reached at 30 wt % loading (with the exception of the BISF epoxy formulations). A further increase in loading to 50 wt % did not result in further increase in fracture toughness. Overall, the samples including the thermoplastic additives of Examples 2 and 4 showed greater improvements in fracture toughness compared to the samples using the thermoplastic additives of Examples 1 and 3.

When the molecular weight of the thermoplastic additive is lower, the mechanical properties, in particular the fracture toughness, of the cured thermosets are expected to be significantly reduced. Surprisingly, at 30 wt % loadings of the thermoplastic additives of Examples 2 and 4, DGEBA and TGDDM cured samples had a greater critical strain energy release than DGEBA and TGDDM cured samples with 30 wt % loadings of PESU, which has a higher molecular weight.

As shown in Table 7, the T_{g} of the cured samples including the thermoplastic additive of either Example 2 or 4 were similar to the T_{g} of the cured samples including PEI or PESU. All of the samples had a single T_{g}. These results demonstrate that the functionalized polyetherimides can be used for applications involving extended exposure to elevated temperatures. The incorporation of lower molecular weight thermoplastics into curable epoxy composition are expected to lower the thermal performance of the resulting cured epoxy thermosets. Surprisingly, DSC measurements show that the TGDDM resin can be formulated with amine- or hydroxyl-terminated PEI oligomers having molecular weights of 5 or 10 kg/mol without compromising high-temperature performance.

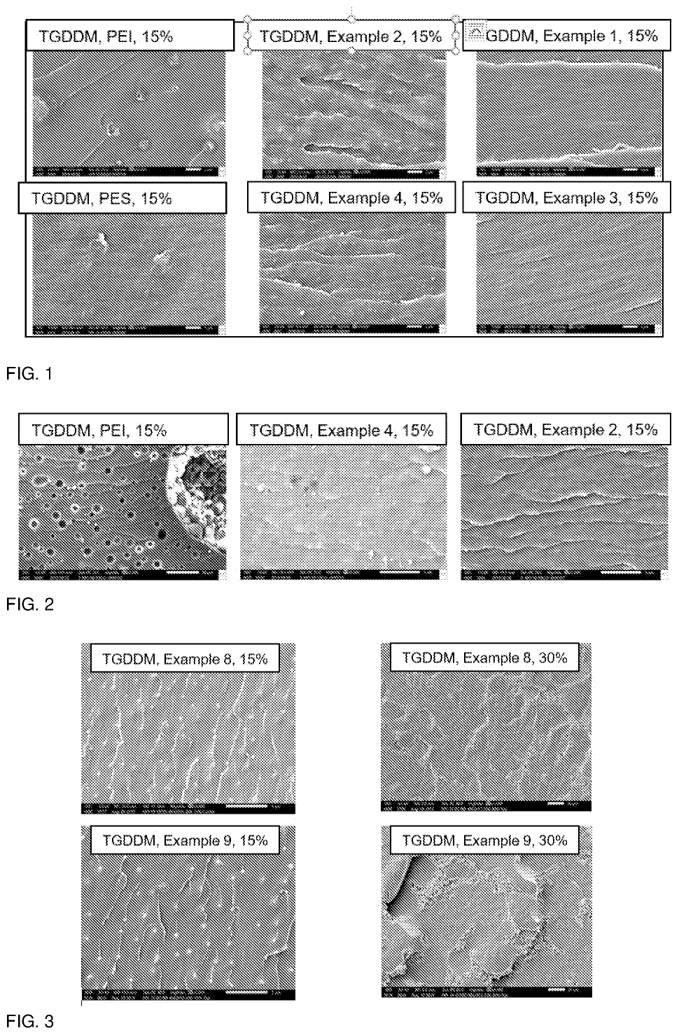

FIG. 1 shows the SEM micrographs of the fractured surfaces of thermoplastic polymer toughened TGDDM epoxy samples, as obtained from the fracture toughness evaluation. At 15 wt % loading of PEI, a clear phase separation (spherical features) is observed in the SEM images of the fractured surfaces. In addition, a phase-inverted region where the spherical particles comprise the cross-linked epoxy held together by PEI, is also shown here. The cured compositions of Examples 2 and 4 show a two-phase morphology with smaller thermoplastic domains (0.1-0.2 μm) uniformly distributed in the epoxy matrix. Without being bound by theory, the PEI oligomers of Examples 2 and 4 react with the epoxy resin and become integrated into the epoxy network, thereby increasing the average molecular weight between cross-links.

Surprisingly, no features were observed for the cured compositions of Examples 1 and 3. The higher fracture toughness of samples including thermoplastic additives of Examples 2 and 4 can thus be explained by this difference in the phase morphology. Further, as the molecular weight increased to 33,000 g/mol and loading level increased to 30 wt %, a two-phase morphology with intermittent co-continuous phases were observed for both 26,000 g/mol and 30, 000 g/mol molecular weight amine-terminated PEI oligomers.

The chemical resistance was evaluated by dipping of the cured thermosets in methylene chloride for 30 mins to 1 hour. FIG. 2 shows the SEM images of the surfaces before and after exposure to methylene chloride. For samples including PEI, etched regions were observed on the surface due to the dissolution of PEI in methylene chloride. The cured thermosets including the PEI oligomers of Examples 2 and 4 showed no damage to the surface by visual observation and SEM imaging, indicating improved chemical resistance.

This disclosure further encompasses the following aspects, which are non-limiting.

Aspect 1. A curable epoxy composition, comprising: an epoxy resin composition comprising one or more epoxy resins, each independently having at least two epoxy groups per molecule; an epoxy resin curing agent; optionally a curing catalyst; and a functionalized polyetherimide prepared from a substituted or unsubstituted C₄₋₄₀ bisanhydride, a substituted or unsubstituted C₁₋₄₀ organic diamine, and optionally an organic compound, wherein the functionalized polyetherimide is present in an amount from 5 to 75 parts by weight per 100 parts by weight of the epoxy resin composition, wherein the functionalized polyetherimide includes a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof; wherein G is an anhydride group, a carboxylic acid, a carboxylic ester, or a combination thereof; wherein the functionalized polyetherimide has a total reactive end group concentration of 50 to 1,500 μeq/g, preferably 50 to 1,000 μeq/g, more preferably 50 to 750 veq/g of the functionalized polyetherimide, wherein the polyetherimide composition has 0.05 to 1,000 ppm by weight, preferably 0.05 to 500 ppm by weight, more preferably 0.05 to 250 ppm by weight of residual organic diamine, based on the total weight of the polyetherimide composition, wherein the functionalized polyetherimide is obtained by precipitation from a solution using an organic anti-solvent, or by devolatilization, and wherein the organic compound comprises at least two functional groups per molecule, wherein a first functional group is reactive with an anhydride group, an amine group, or a combination thereof, and the first functional group is different from a second functional group.

Aspect 2. The curable epoxy composition of aspect 1, wherein the epoxy resin composition comprises a compound of formula (1) as provided herein.

Aspect 3. The curable epoxy composition of aspect 1 or 2, wherein the epoxy resin curing agent is a diamine compound; preferably m-phenylenediamine, p-phenylenediamine, o-phenylenediamine, 3,3′-oxydianiline, 3,4′-oxydianiline, 4,4′-oxydianiline, 1,3-bis(4-aminophenoxy)benzene, 1,3-bis(3-aminophenoxy)benzene, 4,4′-diaminodiphenyl sulfone, 3,3′-diaminodiphenyl sulfone, 3,4′-diaminodiphenyl sulfone, 4,4′-methylenebis-(2,6-diethylaniline), 4,4′-methylenedianiline, diethyltoluenediamine, 4,4′-methylenebis-(2,6-dimethylaniline), 2,4-bis(p-aminobenzyl)aniline, 3,5-diethyltoluene-2,4-diamine, 3,5-diethyltoluene-2,6-diamine, m-xylylenediamine, p-xylylenediamine, diethyl toluene diamine, or a combination thereof; more preferably 4,4′-diaminodiphenyl sulfone.

Aspect 4. The curable epoxy composition of any one or more of the preceding aspects, wherein the functionalized polyetherimide comprises one or more of: a weight average molecular weight of 5,000 to 45,000 g/mol, preferably 10,000 to 45,000 g/mol, more preferably 15,000 to 35,000 g/mol as determined by GPC; a maximum absolute particle size of 1 to 1,000 micrometers, preferably 1 to 500 micrometers, more preferably 1 to 100 micrometers, even more preferably 1 to 75 micrometers; an average degree of reactive end group functionality of greater than 0.75, preferably greater than 0.9, more preferably greater than 1.1, even more preferably greater than 1.5, wherein average degree of reactive end group functionality is defined as the average number of reactive end groups per polyetherimide chain; a glass transition temperature of 155° C. to 280° C., preferably 175° C. to 280° C., more preferably 190° C. to 280° C., as determined by differential scanning calorimetry per ASTM D341; an amide-acid concentration of 0.5 to 5000 microequivalents per gram, preferably 0.5 to 1000 microequivalents per gram, more preferably 0.5 to 500 microequivalents per gram of the functionalized polyetherimide, as determined by nuclear magnetic resonance spectroscopy; greater than 0.05 ppm by weight, preferably greater than 100 ppm by weight, more preferably greater than 500 ppm by weight, even more preferably greater than 1000 ppm by weight of a non-reactive end groups, as determined by nuclear magnetic resonance spectroscopy; 0.05 to 1,000 ppm by weight, preferably 0.05 to 500 ppm by weight, more preferably 0.05 to 250 ppm by weight of residual organic diamine, based on the total weight of the polyetherimide composition, as determined by ultra-performance liquid chromatography; and a polydispersity of less than 4.5, preferably less than 4.0, more preferably less than 3.0, even more preferably less than 2.8, as determined by gel permeation chromatography using polystyrene standards.

Aspect 5. The curable epoxy composition of any one or more of the preceding aspects, wherein the functionalized polyetherimide powder comprises units of formula:

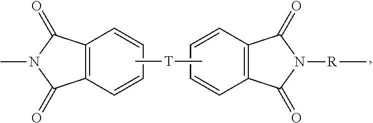

wherein T and R are as provided herein.

Aspect 6. The curable epoxy composition of aspect 5, wherein each R is independently a divalent group of the formula

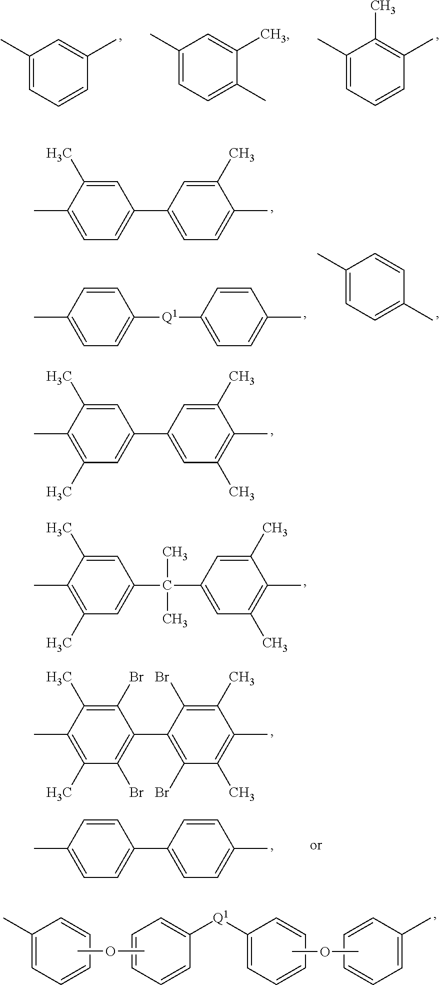

wherein Q¹ is —O—, —S—, —C(O)—, —SO₂—, —SO—, —P(R′)(═O)— wherein R′ is a C₁₋₈ alkyl or C₆₋₁₂ aryl, —C_{y}H_{2y}— and a halogenated derivative thereof wherein y is an integer from 1 to 5, or —(C₆H₁₀)_{z}— wherein z is an integer from 1 to 4; and Z is a group of the formula

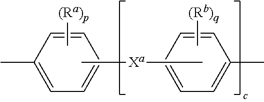

wherein R^{a} and R^{b} are each independently a halogen atom or a monovalent C₁₋₆ alkyl group, p and q are each independently integers of 0 to 4, c is 0 to 4, and X^{a} is a single bond, —O—, —S—, —S(O)—, —SO₂—, —C(O)—, —P(R^{a})(═O)— wherein R^{a} is a C₁₋₈ alkyl or C₆₋₁₂ aryl, or a C₁₋₁₈ organic bridging group; preferably wherein each R is independently meta-phenylene, ortho-phenylene, para-phenylene, bis(4,4′-phenylene)sulfonyl, bis(3,4′-phenylene)sulfonyl, bis(3,3′-phenylene)sulfonyl, bis(4,4′-phenylene)oxy, bis(3,4′-phenylene)oxy, bis(3,3′-phenylene)oxy, or a combination thereof, and each Z is 4,4′-diphenylene isopropylidene.

Aspect 7. The functionalized polyetherimide of any one or more of the preceding aspects, wherein the polyetherimide comprises units of the formula

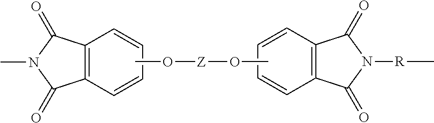

wherein R and Z are as defined herein.

Aspect 8. The curable epoxy composition of any one or more of the preceding aspects, wherein the organic compound is of the formula R^{c}-Lₙ-Q²-Lₙ-R^{d} wherein R^{c} and R^{d} are the different, and are each independently —OH, —NH₂, —SH, or an anhydride group, a carboxylic acid or a carboxylic ester group, each L is the same or different, and are each independently a substituted or unsubstituted C₁₋₁₀ alkylene or a substituted or unsubstituted C₆₋₂₀ arylene, Q² is —O—, —S—, —S(O)—, —SO₂—, —C(O)—, or a C₁₋₄₀ organic bridging group, preferably a substituted or unsubstituted C₁₋₁₀ alkylene or a substituted or unsubstituted C₆₋₂₀ arylene, and each n is independently 0 or 1; more preferably wherein the organic compound is para-aminophenol, meta-aminophenol, ortho-aminophenol, 4-hydroxy-4′-aminodiphenylpropane, 4-hydroxy-4′-aminodiphenylmethane, 4-amino-4′-hydroxydiphenyl sulfone, 4-hydroxy-4′-aminodiphenyl ether, 2-hydroxy-4-aminotoluene, 4-aminothiophenol, 3-aminothiophenol, 2-aminothiophenol, 4-hydroxyphthalic anhydride, 3-hydroxyphthalic anhydride, 6-amino-2-naphthol, 5-amino-2-naphthol, 8-amino-2-naphthol, 3-amino-2-naphthol, or a combination thereof.

Aspect 9. The curable epoxy composition of any one or more of the preceding aspects, wherein a viscosity of the curable epoxy composition is less than or equal to 2,000 Pa·s, preferably less than or equal to 1,000 Pa·s, more preferably less than or equal to 500 Pa·s, as measured at 100° C. per ASTM D4440-1.

Aspect 10. The curable epoxy composition of any one or more of the preceding aspects, further comprising a particulate filler, a fibrous filler, an antioxidant, a heat stabilizer, a light stabilizer, a ultraviolet light stabilizer, a ultraviolet light-absorbing compound, a near infrared light-absorbing compound, an infrared light-absorbing compound, a plasticizer, a lubricant, a release agent, a antistatic agent, storage stabilizer, ozone inhibitors, optical stabilizer, thickener, conductivity-impacting agent, radiation interceptor, nucleating agent, an anti-fog agent, an antimicrobial agent, a metal inactivating agent, a colorant, a surface effect additive, a radiation stabilizer, a flame retardant, an anti-drip agent, a fragrance, an adhesion promoter, a flow enhancer, a coating additive, a polymer different from the one or more epoxy resins, or a combination thereof.

Aspect 11. The curable epoxy composition of any one or more of the preceding aspects, further comprising polyarylate, polyamide, polyimide, polyetherimide, poly(amide imide), poly(aryl ether), phenoxy resins, poly(aryl sulfone), poly(ether sulfone), poly(phenylene sulfone), poly(ether ketone), poly(ether ether ketone), poly(ether ketone ketone), poly(aryl ketone), poly(phenylene ether), polycarbonate, carboxyl-terminated butadiene-acrylonitrile rubber (CTBN), amine-terminated butadiene-acrylonitrile rubber (ATBN), epoxy-terminated butadiene-acrylonitrile rubber (ETBN), core-shell rubber, or a combination thereof.

Aspect 12. A method for the manufacture of the curable epoxy composition of any one or more of the preceding aspects, the method comprising: combining the epoxy resin composition and the functionalized polyetherimide at a temperature of 70 to 200° C. to provide a reaction mixture; and adding the epoxy resin curing agent and optionally the curing catalyst to the reaction mixture to provide the curable epoxy composition.

Aspect 13. An epoxy thermoset comprising a cured product of the curable epoxy composition of any one or more of the preceding aspects.

Aspect 14. The epoxy thermoset of aspect 13, which after curing has at least one of: a glass transition temperature of 50 to 300° C., preferably 150 to 300° C., more preferably 190 to 300° C., even more preferably 210 to 300° C. or even more preferably 230 to 300° C., as determined by DSC per ASTM D3418; or a fracture toughness of greater than or equal to 150 J/m², preferably greater than or equal to 200 J/m², more preferably greater than or equal to 250 J/m² per ASTM D5045; or a solvent resistance to methylene chloride, tetrachloroethane, dichlorobenzene, chloroform, dichloroethane, methyl ethyl ketone, acetone, methyl isobutyl ketone, methyl isopropyl ketone, ethyl acetate, N-methyl pyrrolidone, dimethylacetamide, dimethylformamide, dimethylsulfoxide, hydraulic fluid, jet fuel, gasoline, an alcohol, or a combination thereof.

Aspect 15. An article comprising the epoxy thermoset of aspect 13 or 14, preferably wherein the article is in the form of a composite, an adhesive, a film, a layer, a coating, an encapsulant, a sealant, a component, a prepreg, a casing, or a combination thereof.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

The singular forms “a,” “an,” and “the” include plural referents unless the context clearly dictates otherwise. “Or” means “and/or” unless clearly indicated otherwise by context. The terms “first,” “second,” and the like, do not denote any order, quantity, or importance, but rather are used to distinguish one element from another. Reference throughout the specification to “an aspect” means that a particular element described in connection with the aspect is included in at least one aspect described herein, and may or may not be present in other aspects. The described elements can be combined in any suitable manner in the various aspects. “Combinations” is inclusive of blends, mixtures, alloys, reaction products, and the like. “Combination thereof” as used herein is an open term and refers to a combination comprising one or more of the listed items, optionally with one or more like items not listed.

All ranges disclosed herein are inclusive of the endpoints, and the endpoints are independently combinable with each other. The endpoints of all ranges directed to the same component or property are inclusive and independently combinable. Disclosure of a narrower range or more specific group in addition to a broader range is not a disclaimer of the broader range or larger group.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

As used herein, the term “hydrocarbyl” includes groups containing carbon, hydrogen, and optionally one or more heteroatoms (e.g., 1, 2, 3, or 4 atoms such as halogen, O, N, S, P, or Si). “Alkyl” means a branched or straight chain, saturated, monovalent hydrocarbon group, e.g., methyl, ethyl, i-propyl, and n-butyl. “Alkylene” means a straight or branched chain, saturated, divalent hydrocarbon group (e.g., methylene (—CH₂—) or propylene (—(CH₂)₃—)). “Alkenyl” and “alkenylene” mean a monovalent or divalent, respectively, straight or branched chain hydrocarbon group having at least one carbon-carbon double bond (e.g., ethenyl (—HC═CH₂) propenylene (—HC(CH₃)═CH₂—). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy, ethoxy, and sec-butyloxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclization(s). “Aryl” means a monovalent, monocyclic, or polycyclic aromatic group (e.g., phenyl or naphthyl). “Arylene” means a divalent aryl group. “Alkylaryl” means an aryl group substituted with an alkyl group. “Arylalkyl” means an alkyl group substituted with an aryl group (e.g., benzyl). The prefix “halo” means a group or compound including one more halogen (F, Cl, Br, or I) substituents, which can be the same or different. The prefix “hetero” means a group or compound that includes at least one ring member that is a heteroatom (e.g., 1, 2, or 3 heteroatoms), wherein each heteroatom is independently N, O, S, or P.

Unless substituents are otherwise specifically indicated, each of the foregoing groups can be unsubstituted or substituted, provided that the substitution does not significantly adversely affect synthesis, stability, or use of the compound. “Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkyl (e.g., benzyl), C₇₋₁₂ alkylaryl (e.g., toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. The number of carbon atoms indicated in a group is exclusive of any substituents. For example —CH₂CH₂CN is a C₂ alkyl group substituted with a nitrile.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A curable epoxy composition, comprising:
an epoxy resin composition comprising one or more epoxy resins, each independently having at least two epoxy groups per molecule;
an epoxy resin curing agent;
optionally a curing catalyst; and
a functionalized polyetherimide prepared from a substituted or unsubstituted C₄₋₄₀ bisanhydride, a substituted or unsubstituted C₁₋₄₀ organic diamine, and optionally an organic compound, wherein the functionalized polyetherimide is present in an amount from 5 to 75 parts by weight per 100 parts by weight of the epoxy resin composition,
wherein the functionalized polyetherimide comprises a reactive end group of the formula (C₁₋₄₀ hydrocarbylene)-NH₂, (C₁₋₄₀ hydrocarbylene)-OH, (C₁₋₄₀ hydrocarbylene)-SH, (C₄₋₄₀ hydrocarbylene)-G, or a combination thereof,
wherein G is an anhydride group, a carboxylic acid, a carboxylic ester, or a combination thereof,
wherein the functionalized polyetherimide has a total reactive end group concentration of 50 to 1,500 microequivalents per gram, as determined by nuclear magnetic resonance spectroscopy,
wherein the polyetherimide composition has 0.05 to 1,000 ppm by weight, based on the total weight of the polyetherimide composition, as determined by ultra-performance liquid chromatography,
wherein the functionalized polyetherimide is obtained by precipitation from a solution using an organic anti-solvent, or by devolatilization, and
wherein the organic compound comprises at least two functional groups per molecule, wherein a first functional group is reactive with an anhydride group, an amine group, or a combination thereof, and the first functional group is different from a second functional group.

2. The curable epoxy composition of claim 1, wherein the epoxy resin composition comprises a compound of the formula 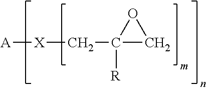
wherein
A is an inorganic group or a C₁₋₆₀ hydrocarbyl group of valence n, X is oxygen or nitrogen, m is 1 or 2 and consistent with the valence of X, R is hydrogen or methyl, and n is 1 to 100.

3. The curable epoxy composition of claim 1, wherein the epoxy resin curing agent is a diamine compound.

4. The curable epoxy composition of claim 1, wherein the functionalized polyetherimide comprises one or more of:
a weight average molecular weight of 5,000 to 45,000 grams per mole, as determined by gel permeation chromatography using polystyrene standards;
a maximum absolute particle size of 1 to 1,000 micrometers, as determined by pore size of a sieve used to isolate the functionalized polyetherimide;
an average degree of reactive end group functionality of greater than 0.75, wherein average degree of reactive end group functionality is defined as the average number of reactive end groups per polyetherimide chain;
a glass transition temperature of 155° C. to 280° C., as determined by differential scanning calorimetry per ASTM D341;
an amide-acid concentration of 0.5 to 5000 microequivalents per gram, functionalized polyetherimide, as determined by nuclear magnetic resonance spectroscopy;
greater than 0.05 ppm by weight, as determined by nuclear magnetic resonance spectroscopy;
0.05 to 1,000 ppm by weight, based on the total weight of the polyetherimide composition, as determined by ultra-performance liquid chromatography; and
a polydispersity of less than 4.5, as determined by gel permeation chromatography using polystyrene standards.

5. The curable epoxy composition of claim 1, wherein the functionalized polyetherimide powder comprises units of the formula 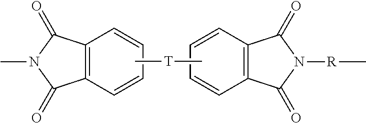
wherein
each R is the same or different and is independently a substituted or unsubstituted divalent C₁₋₄₀ organic group, preferably a substituted or unsubstituted divalent C₆₋₂₀ aromatic hydrocarbon group, a substituted or unsubstituted C₄₋₂₀ alkylene group, or a substituted or unsubstituted C₃₋₈ cycloalkylene group; and
T is —O— or a group of the formula —O—Z—O— wherein Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded.

6. The curable epoxy composition of claim 5, wherein
each R is independently a divalent group of the formula 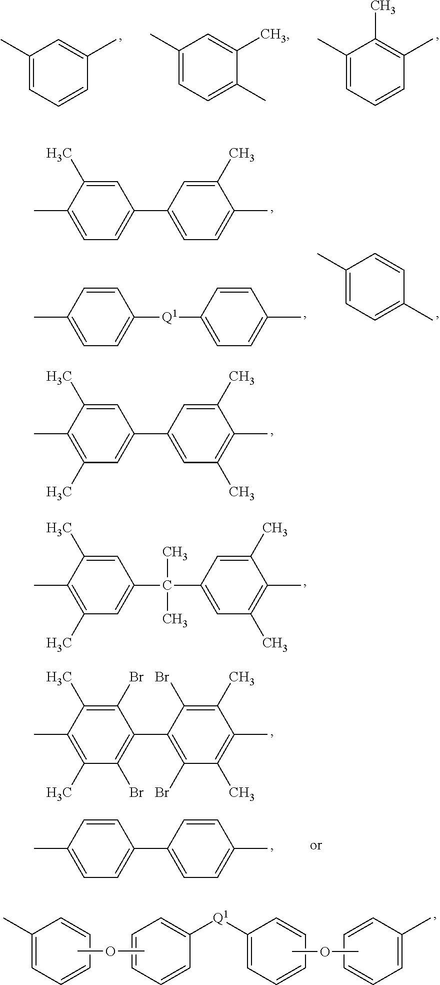
wherein
Q¹ is —O—, —S—, —C(O)—, —SO₂—, —SO—, —P(R′)(═O)— wherein R′ is a C₁₋₈ alkyl or C₆₋₁₂ aryl, —C_{y}H_{2y}— and a halogenated derivative thereof wherein y is an integer from 1 to 5, or —(C₆H₁₀)_{z}— wherein z is an integer from 1 to 4; and
Z is a group of the formula 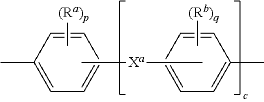
wherein
IV and R^{b} are each independently a halogen atom or a monovalent C₁₋₆ alkyl group,
p and q are each independently integers of 0 to 4,
c is 0 to 4, and
X^{a} is a single bond, —O—, —S—, —S(O)—, —SO₂—, —C(O)—, —P(R^{a})(═O)— wherein It' is a C₁₋₈ alkyl or C₆₋₁₂ aryl, or a C₁₋₁₈ organic bridging group.

7. The curable epoxy composition of claim 1, wherein the polyetherimide comprises units of the formula 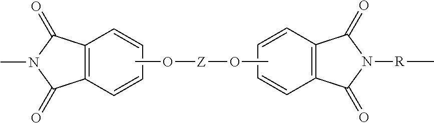
wherein
each R is the same or different and is independently a substituted or unsubstituted divalent C₁₋₄₀ organic group, and
Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded.

8. The curable epoxy composition of claim 1, wherein the organic compound is of the formula
R^{c}-Lₙ-Q²-Lₙ-R^{d}
wherein
R^{c} and R^{d} are the different, and are each independently —OH, —NH₂, —SH, or an anhydride group or a carboxylic acid, or a carboxylic ester,
each L is the same or different, and are each independently a substituted or unsubstituted C₁₋₁₀ alkylene or a substituted or unsubstituted C₆₋₂₀ arylene,
Q² is —O—, —S—, —S(O)—, —SO₂—, —C(O)—, or a C₁₋₄₀ organic bridging group, and
each n is independently 0 or 1.

9. The curable epoxy composition of claim 1, wherein a viscosity of the curable epoxy composition is less than or equal to 2,000 Pa·s, preferably less than or equal to 1,000 Pa·s, as measured at 100° C. according to ASTM D4440-1.

10. The curable epoxy composition of claim 1, further comprising a particulate filler, a fibrous filler, an antioxidant, a heat stabilizer, a light stabilizer, a ultraviolet light stabilizer, a ultraviolet light-absorbing compound, a near infrared light-absorbing compound, an infrared light-absorbing compound, a plasticizer, a lubricant, a release agent, a antistatic agent, storage stabilizer, ozone inhibitors, optical stabilizer, thickener, conductivity-impacting agent, radiation interceptor, nucleating agent, an anti-fog agent; an antimicrobial agent, a metal inactivating agent, a colorant, a surface effect additive, a radiation stabilizer, a flame retardant, an anti-drip agent, a fragrance, an adhesion promoter, a flow enhancer, a coating additive, a polymer different from the one or more epoxy resins, or a combination thereof.

11. The curable epoxy composition of claim 1, further comprising polyarylate, polyamide, polyimide, polyetherimide, poly(amide imide), poly(aryl ether), phenoxy resins, poly(aryl sulfone), poly(ether sulfone), poly(phenylene sulfone), poly(ether ketone), poly(ether ether ketone), poly(ether ketone ketone), poly(aryl ketone), poly(phenylene ether), polycarbonate, carboxyl-terminated butadiene-acrylonitrile rubber (CTBN), amine-terminated butadiene-acrylonitrile rubber (ATBN), epoxy-terminated butadiene-acrylonitrile rubber (ETBN), core-shell rubber, or a combination thereof.

12. A method for the manufacture of the curable epoxy composition of claim 1, the method comprising:
combining the epoxy resin composition and the functionalized polyetherimide at a temperature of 70 to 200° C. to provide a reaction mixture; and
adding the epoxy resin curing agent and optionally the curing catalyst to the reaction mixture to provide the curable epoxy composition.

13. An epoxy thermoset comprising a cured product of the curable epoxy composition of claim 1.

14. The epoxy thermoset of claim 13, which after curing has at least one of:
a glass transition temperature of 50 to 300 ° C., as determined by differential scanning calorimetry per ASTM D3418; or
a fracture toughness of greater than or equal to 150 Joules per square meter, as measured according to ASTM D5045; or
a solvent resistance to methylene chloride, tetrachloroethane, dichlorobenzene, chloroform, dichloroethane, methyl ethyl ketone, acetone, methyl isobutyl ketone, methyl isopropyl ketone, ethyl acetate, N-methyl pyrrolidone, dimethylacetamide, dimethylformamide, dimethylsulfoxide, hydraulic fluid, jet fuel, gasoline, an alcohol, or a combination thereof.

15. An article comprising the epoxy thermoset of claim 13.

16. The article of claim 15, wherein the article is in the form of a composite, an adhesive, a film, a layer, a coating, an encapsulant, a sealant, a component, a prepreg, a casing, or a combination thereof.

17. The method of claim 15, wherein the functionalized polyetherimide powder comprises units of the formula 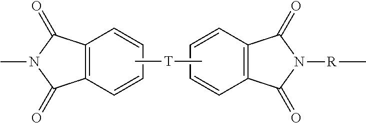
wherein
each R is the same or different and is independently a substituted or unsubstituted divalent C₁₋₄₀ organic group, preferably a substituted or unsubstituted divalent C₆₋₂₀ aromatic hydrocarbon group, a substituted or unsubstituted C₄₋₂₀ alkylene group, or a substituted or unsubstituted C₃₋₈ cycloalkylene group; and
T is —O— or a group of the formula —O—Z—O— wherein Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded.

18. The method of claim 17, wherein each R is independently a divalent group of the formula 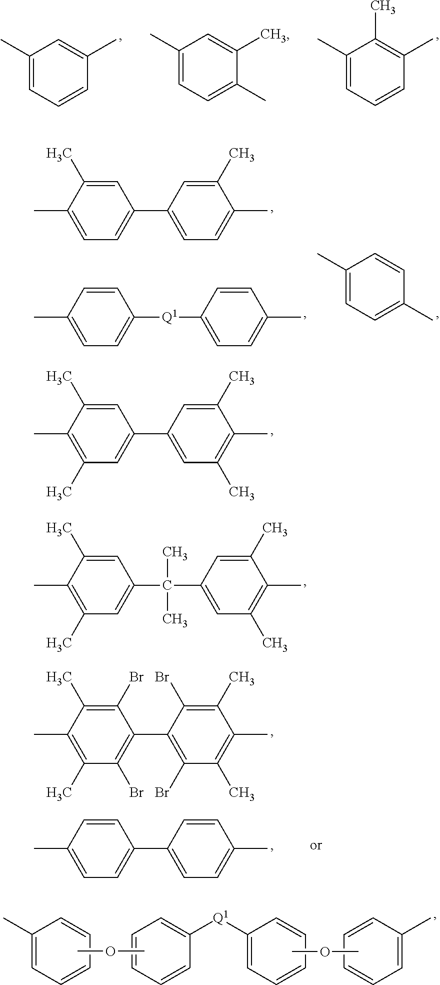
wherein
Q¹ is —O—, —S—, —C(O)—, —SO₂—, —SO—, —P(R′)(═O)— wherein R′ is a C₁₋₈ alkyl or C₆₋₁₂ aryl, —C_{y}H_{2y}— and a halogenated derivative thereof wherein y is an integer from 1 to 5, or —(C₆H₁₀)_{z}— wherein z is an integer from 1 to 4; and
Z is a group of the formula 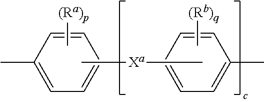
wherein
R^{a} and R^{b} are each independently a halogen atom or a monovalent C₁₋₆ alkyl group,
p and q are each independently integers of 0 to 4,
c is 0 to 4, and
X^{a} is a single bond, —O—, —S—, —S(O)—, —SO₂—, —C(O)—, —P(R^{a})(═O)— wherein Ra is a C₁₋₈ alkyl or C₆₋₁₂ aryl, or a C₁₋₁₈ organic bridging group.

19. The method of claim 15, wherein the polyetherimide comprises units of the formula 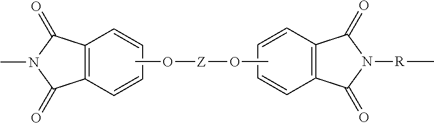
wherein
each R is the same or different and is independently a substituted or unsubstituted divalent C₁₋₄₀ organic group, and
Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded.

20. The method of claim 12, wherein the organic compound is of the formula
R^{c}-Lₙ-Q²-Lₙ-R^{d}
wherein
R^{c} and R^{d} are the different, and are each independently —OH, —NH₂, —SH, or an anhydride group or a carboxylic acid, or a carboxylic ester,
each L is the same or different, and are each independently a substituted or unsubstituted C₁₋₁₀ alkylene or a substituted or unsubstituted C₆₋₂₀ arylene,
Q² is —O—, —S—, —S(O)—, —SO₂—, —C(O)—, or a C₁₋₄₀ organic bridging group, and
each n is independently 0 or 1.
